(19) United States
(12) Patent Application Publication
(10) Pub. No.: US 2007/0122781 A1
(43) Pub. Date: May 31, 2007

(54) Visual psychoanalytic unification system and method for dating, mating sequence and relationship problem solving

(76) Inventor: Paul Dobransky, Chicago, IL (US)

Correspondence Address: Donald W. Meeker;Patent Agent, 924 East Ocean Front #E, Newport Beach, CA, 92661, US

(21) Appl. No.: 11/605,761

(22) Filed: Nov. 29, 2006

Related U.S. Application Data
(60) Provisional application No. 60/597,420, filed on Nov. 29, 2005.

(51) Int. Cl. G09B 19/00

(52) U.S. Cl. 434/236

(57) ABSTRACT

Visual and geometric diagrams used therapeutically for devising an effective personal dating process, human mating sequence, and human mood, failure, and relationship analysis and problem solving. A combined mind operating system including a personality identification and treatment applied in a dating operating system and method to teach, coach and deliver therapy for personal growth, character growth, relationship analysis and corrective advice for individuals and corporations.

### CROSS-REFERENCE TO RELATED APPLICATIONS

The present utility patent application claims the benefit of provisional application No. 60/597,420, filed Nov. 29, 2005.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

This invention relates to a system of psychoanalysis and more particularly, but not by way of limitation, to a visual psychoanalytic unification system using visual and geometric diagrams for devising an effective personal dating process, human mating sequence, and human mood, failure, and relationship analysis and personal and corporate problem solving. The visual psychoanalytic unification system is designed to teach, coach and deliver therapy for personal growth, character growth, relationship analysis and corrective advice and called “Mind OS” (“mind operating system”) and its specific use as a system of analysis of dating, mating sequence and relationship analysis is termed “Dating OS,” (“dating operating system”) called “the 3 brains problem-solving system.” The subject mind operating system has incorporated within it, an original system of personality identification and treatment called “KWML” (“King, Warrior, Magician, Lover”) devised by the present inventor.

2. Description of Related Art Including Information Disclosed Under 37 CFR 1.97 and 1.98

The subject mind operating system of the present invention is based on a new unification theory of modern methods of psychology, economics and psychotherapy. The subject mind operating system and dating operating system is a novel synthesis of these methods formally known as, but not limited to psychodynamic psychotherapy, transactional analysis, self-psychology, object relations, cognitive-behavioral therapy, dialectical behavioral therapy, evolutionary psychology, positive psychology, interpersonal therapy, group therapy, solution-focused therapy, neurolinguistic programming, Jungian therapy, and the Nash Equilibrium, from the tenets of the Game Theory of Economics.

Prior art systems fail to provide a comprehensive effective integration of all the theories and therapies.

In U.S. Pat. No. 5,696,981 to Shovers, a personality analyzer is described using a patient's responses to a predefined quiz, flashcards, monograph and monologue. In U.S. Pat. No. 6,425,764 to Lamson, a virtual reality immersion therapy is disclosed. The therapy is used for treating psychological, psychiatric, medical, educational and self-help problems. In U.S. Pat. No. 6,497,577 to Kanter, a system and method for improving emotional awareness and self-mastery is described. In U.S. Pat. No. 6,715,762 to Simmons, a system for enhancing and improving communication between two people is disclosed using a playing hand of a card game.

U.S. Patent Application #20040180312, published Sep. 16, 2004 by Covi, shows an instructive system for encouraging self actualization to aid students in finding greater satisfaction in life through greater understanding of how the student's experiences, perceptions, characteristics, fears and the development and implementation of the student's Will affect the student's attitudes and ability to succeed. Embodiments of the invention comprise the use of adventure, imagery, inquiry and explanation to engage the student in psychoanalytical methods of communication to allow the student to reflect upon the student's answers to introspective questions at a “safe” distance. Specific exemplary embodiments of the invention include embodying the invention as a book, an interactive action video game, an audio book, a seminar, a media presentation, an interactive storyboard, an interactive adventure park, a theme park, and an Internet link.

U.S. Pat. No. 5,696,981, issued Dec. 9, 1997 to Shovers, is for devices and methods for analyzing a subject's personality using an automated personality analyzer. A subject's responses to a predefined quiz, responses to flashcards, a monograph, or a monologue, is used to determine the subject's likely personality type. The subject's choice and usage of words, and in particular certain “key words”, are categorized, scored, and weighted in accordance with an aspect of the invention. The sums of these weighted scores are used to compare the subject to predefined pure personality type, so as to gain insight to the subject's psychological state and personality.

U.S. Pat. No. 6,425,764, issued Jul. 30, 2002 to Lamson, provides a virtual reality immersion therapy for treating psychological, psychiatric, medical, educational, and self-help problems. A method is provided of treating a psychological, psychiatric, or medical condition by choosing a psychological strategy for treating the condition, encoding electronic instructions for a virtual reality environment in such a way that the interactive virtual reality environment implements the psychological strategy, loading electronic instructions into a virtual reality technology unit equipped with a display for displaying the virtual reality environment and with a patient input device for receiving responses to the environment from the patient, and instructing the human patient how and when to use the virtual reality technology unit to interact with the environment. The interactive environment contains instructions for a scoring procedure for quantitatively analyzing the medical condition of the patient, and/or counseling instructions or self-help instructions. The environment can be used in conjunction with a physical parameter measuring device connected to the virtual reality technology unit. The process is comprehensive and takes place during immersion in fully interactive three-dimensional virtual reality environments utilizing computer generated graphics, images imported from photographs, and video for sensory stimulation. Immersion is achieved with goggles, a head-mounted-display, or other form of visual stimulation, such as surround projection screens or monitors or devices that permit the user to have a virtual experience. It includes the use of voice, music, and sound and other forms of physiological stimulation and feedback. Body sensors and devices such as a hand-held grip permit the user to interact with objects and navigate within the virtual environment.

U.S. Pat. No. 6,497,577, issued Dec. 24, 2002 to Kanter, shows various systems and methods for providing an individual with improved emotional awareness and self-mastery. The systems and methods allow an individual to recall a situation in which the he or she experienced negative emotions. Then, the individual is able to analyze the recalled situation to identify specific negative emotions (specifically “flight” or “fight” emotions) experienced during the particular situation. Once the individual has identified specific negative emotions that were experienced during the particular situation, the systems and methods of this invention correlate each identified emotion with an underlying spiritual need. When the appropriate spiritual need(s) have been identified, the systems and methods of this invention identify at least one antidote to the spiritual need(s). The antidote(s) are then relayed to the individual for personal application. In this manner, an individual can evaluate the negative emotion(s) experienced during a particular situation and receive guidance as to how he or she can cultivate virtuous behavior that will overcome the negative emotions.

U.S. Pat. No. 6,715,762, issued Apr. 6, 2004 to Simmons, claims a system for providing entertainment and enhancing human relationships. The system allows two or more people to improve communication, understanding and/or relationships. The persons engage in a game or other activity where there are triggering events, such as completing a hand of a game of cards, or expiration of a time period. When there is a triggering event, one person selects an item of information at random (e.g. by drawing a card from a stack of information cards). The person reads the information and expresses a thought relating to the same. The other participants are then also able to comment. If this discussion becomes objectionable in some way, one of the participants can activate a “defuser” to either divert the line of discussion or terminate the discussion, after which the activity phase (e.g. a card game, a counseling session, etc.) is continued.

U.S. Pat. No. 5,676,551, issued Oct. 14, 1997 to Knight, describes an interactive presentation and/or entertainment system, such as interactive personal computer software and/or interactive television, which allows a participant to modulate the emotions of a character or personality, thereby influencing the branches to an interpersonal relationship over time. As a result, a broad range of computerized dramatic situations or stories are presented that closely resemble human interpersonal relationships. Source image/sound data may include prerecorded video, prerecorded audio, computer-based audio, computer-based imagery, computer-generated dialogue, and/or computer-generated characters. The range of emotional choices made by a participant may include all emotions that human beings can experience and, in turn, represent by thought, word, or action. Emotions that indicate personality rather than mood are presented, such that the ebb and flow of a character's emotional states is exhibited over an extended period in the course of a many situations and activities, instead of as mere ephemeral reactions to isolated incidents.

Other prior art peripherally related to the present invention include:

Patent application #20050086187: computer-assisted decision making can be for dating.

Patent application #20050179246: Alzheimer's victim decision making kit, mentions dating.

Patent application #20040155452: Student planner to stay on task of attaining goals.

Patent application #5954581: another scenario selector.

Patent application #5813863: behavior modification.

None of the above mentioned prior art patents specifically disclose the unique feature of the subject visual psychoanalysis system and method as described herein.

None of the above mentioned prior art patents specifically disclose the unique combination of theories and therapies of the visual psychoanalytic unification system and method for dating, mating sequence, and relationship problem solving of the present invention as described herein.

### BRIEF SUMMARY OF THE INVENTION

The present invention provides a system and method employing visual and geometric diagrams used therapeutically for devising an effective personal dating process, human mating sequence, and human mood, failure, and relationship analysis and problem solving. A combined mind operating system (Mind OS) including a personality identification and treatment (KWML—King, Warrior, Magician, Lover) are applied in a dating operating system (Dating OS) and method to teach, coach and deliver therapy for personal growth, character growth, relationship analysis and corrective advice and via organizing the visual and conceptual systems devised by the inventor for mental operations in three parts: instinctual, emotional, and “higher-brained” or “cortical,” teach, coach, and deliver corrective analysis and advice on corporate problems involving human interaction.

In analyzing or treating any problem of dating, mating sequence, or relationship problem, the Dating OS is composed of three Phases, of three Steps each—Attraction Phase, followed by Bonding in Friendship Phase, followed by a Commitment Phase to produce in another human, a relationship of Lovers, Friends, and Partners in one relationship, which is durable via sequentially appealing to the “reptilian brain,” “mammalian brain,” and “higher brain” relational needs of another (opposite gender) human, the “mammalian brain” and “higher brain” of which, in coordination through subject systems uses MindOS, and when incorporated with the “reptilian brain” uses subject Dating OS. As applied to corporate problems, the Dating OS system terms the here phases as Instinctual (or Attraction), Friendship, and Commitment.

In the subject dating operating system, the Attraction Phase for women addresses the three brainstem or “reptilian brain” needs of males: 1.) display of beauty, 2.) demonstration of potential elevation of Rank, Territory, or Power (called in Dating OS, “Alpha-male status”) also referred to by the inventor as “standing by your man” or “cheerleading the man” and 3.) creation of a contest or competition for said male to “win” bonding with the woman among other males, also referred to by the inventor as “playing hard to get” or “giving the man a hard time.”

In the subject dating operating system, the Attraction Phase for men addresses the brainstem or “reptilian brain” needs of females: 1.) display of mystery, 2.) demonstration of “Alpha-male status” as detailed above, and 3.) passing the contests created by women (also referred to by the inventor as “slaying the dragons.”)

In the subject dating operating system, the second necessary Phase common to both males and females is the Bonding in Friendship Phase which includes demonstration of 1.) mastery of anger, via the included Anger Map, 2.) mastery of anxiety, via the included Anxiety Map, and 3.) teamwork, personality match and collaboration via the included cognitive-emotional spectrum map. The Bonding in Friendship Phase establishes for the first time that “friendship” among humans is simply defined as “shared positive emotion with another human on a consistent basis,” and so mastery of the steps of Bonding Phase (appealing to the two people's emotional or “mammalian brain” functions) in order demonstrate a growth of potential for durable friendship, which occurring after an Attraction Phase, creates a romantic friendship that includes sexual attraction and tension, binding the two people together in a growing relationship. This phase of the dating operating system makes use of the KWML portion of the subject mind operating system.

In the subject dating operating system, the final sequential phase common once again to both males and females is called Commitment Phase, which adds a Partnership function and durability, through steps of mastery of 1.) Personal Boundary use which demonstrates ability to respect rights, ideas, emotions and decisions of another human, as well as the ability to live by one's word and fulfill a contract to another person, 2.) joining of beliefs and values that are used for approaching mutual Life's Goals, and demonstration of facility in progressing toward such goals, and 3.) Constructive Decision-making, or win/win behavior that demonstrates an “abundance world-view” in deciding to commit to form a partnership, rather than a Destructive Decision-making, or win/lose behavior that demonstrates a “scarcity world-view” which precludes ability to form a durable partnership with another (opposite gender) human in a romantic relationship. This Phase of the subject dating operating system makes use of the personal boundary diagrams, and methods of analysis and repair, decision-making diagrams and methods, intellectual diagrams and methods, and emotional diagrams and methods of the subject mind operating system.

The Dating OS system also describes and systematizes that “beliefs” are composed of ideas paired with quanta of emotional energy (whether positive or negative), and these beliefs form the “bridge” between the “mammalian brain” function and “higher brain” function.

In total then, the Dating OS system incorporates human brainstem or “reptilian brain” function through sexual attraction, with the bonding in friendship and commitment ability of the “mammalian brain” (emotional brain) and “higher brain” (cerebral cortex) relational functions to promote lasting, durable romantic relationships, and a tool for analysis of such relationships that have become dysfunctional or are likely to be in the future. As such it is also predictive of relationship dysfunction in the future of a couple, prescribing corrective measures before they are needed. Since a corporation is legally defined as a “person,” and the subject Mind OS system, KWML, and Dating OS system apply to individuals, the inventor applies the same principles to the analysis and problem-solving of corporate function and problems with the same principles of said systems.

A first object of the subject dating operating system and mind operating system is to provide a person with a visual tool to observe one's self as an “observing ego”. The observing ego allows the person to step outside one's self and then look back into one's self and see how he or she functions. It is the only skill which can allow change or growth in the individual or in the maturity of an individual's psychology.

Another object of the dating operating system and its contained mind operating system is to render all of psychology in the form of diagrams with guiding explanations, both of which economize analysis and correction of personal psychology and sexual attraction function. The mind operating system provides a set of diagrams that will easily allow the person to master the opposite ends of the spectra of each of the three internal psychological resources in an individual, which are contained within the boundary. The three inner resources are emotional energy, intellectual data use, and maturity of decision-making.

One learns to use observing ego to analyze one's self, assisted by the visual representation of psychology. Then seeing the four building blocks of psychology in the form of the personal boundary, emotional energy, intellectual data use, and decision-making, one may learn that the three inner resources (emotional energy, intellectual data use, and decision-making) all exist on spectra of function. Mastery of each end of the spectrum of these three leads to mastery of all possible human resources and behavior, since on a given spectrum, everything possible is located between the two ends of that spectrum. A balance point is then taught to be the middle point of each spectrum. The striving for balance is what leads to each of the three rewards for mastery-happiness, success, and freedom, which along with durability that mastery of the personal boundary affords, compose durable fulfillment.

Mastery of the personal boundary and the three spectra of inner resources within it also lead to the solutions to any human problem, which may also be broken into components corresponding to each of the working parts of a psyche that solve it. Finally, psychological integration, or mature character which solves psychological problems, can be envisioned and guided by crossing the spectra of the inner resources so that balance on them can be strived for simultaneously and measured, corrected or adjusted according to changes in the problem or environment.

The observing ego represents a person viewing oneself. With a mastery of the personal boundary, emotional energy, intellectual data use and decision-making, the person is lead to the rewards of durability, happiness, success and freedom.

The mastery of these four character components and the ends of their spectra of function lead to solutions to any personal problem involving psychology, and to durable fulfillment, which is a summation of durability, happiness, success and freedom. Also the illustrations of emotional energy is shown as an emotional energy spectrum, including a negative emotional energy spectrum and a position emotional energy spectrum, the intellectual data use shown as an intellectual data use spectrum and decision-making shown as a decision-making spectrum.

The dating operating system which includes three “brains” as symbolic of functional strategies that must be undergone by a woman in the human mating sequence include an Attraction Phase, followed by a Bonding in Friendship Phase, followed by a Commitment Phase.

The Attraction Phase includes a communication and appeal by a woman to a man's brainstem/“reptilian brain” sexual attraction mechanism, via display of beauty, followed by demonstration of ability to elevate a man's Rank, Territory, or Power (“Alpha-male status”), followed by the creation of a contest for him to win her attention against other males, or over her testing that impedes sexual advance.

The Bonding in Friendship Phase includes a communication and appeal by a woman to a man's midbrain/“mammalian brain” emotional attraction mechanism, via demonstration of mastery of anger use, followed by mastery of anxiety use and followed by mastery of personality match in friendship proving effective teamwork collaboration.

The Commitment Phase includes a communication, decision, and effort by a woman to a man's cerebral cortex/“Higher brain” intellectual attraction mechanism, via demonstration of mastery of Personal Boundary use, mastery of joining belief systems toward mutual Life's Goals, and mastery of constructive decision-making to commit to a contract of exclusivity with a partner, completing a process of building a relationship with a sexually-attracted Lover in bonded Friendship, as a committed Partner, which in the context of a unique, shared Story, comprises what is defined in said dating operating system is called “Mr. Right.”

These and other objects of the present invention will become apparent to those familiar with various types of psychoanalytic or psychotherapy teachings and methods used with patients when reviewing the following detailed description, showing novel construction, combination, and elements as herein described, and more particularly defined by the claims, it being understood that changes in the various embodiments of invention are meant to be included as coming within the scope of the claims, except insofar as they may be precluded by the prior art.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic view which illustrates the four psychological and individual character “building blocks” or components (personal boundary plus its inner resources) required to reach a goal of the desired durable fulfillment and is an overview of the mind operating system which comprises function of the emotional/“mammalian brain” and cortex/“higher brain” and are components of the dating operating system of the present invention, when the “reptilian brain” function of sexual attraction is placed as the initial phase;

FIG. 2 is a diagrammatic view which illustrates the observing ego when reviewing those psychological resources, which observing ego is the only teachable human skill which allows analysis, change and growth toward maturity of individual psychology, which skill must be acquired at an at least basic level before the details of the rest of the system can be mastered;

FIG. 3 is a diagrammatic view which illustrates the three “brains of Mr. Right” of the present invention which compose the three types of brain function that must be appealed to by a woman in her identifying and establishing a sexual, but durable romantic relationship with a man she considers her “Mr. Right;”

FIG. 4 is a diagrammatic view which illustrates the “three brains of Mr. Right” in which the brainstem or “reptilian brain” is responsible for instinct (7) and therefore sexual attraction, and the emotional or “mammalian brain” combined with the cerebral cortex or “higher brain” are responsible for the “civilizing force” of relationships called character (8) and which promote bonding in friendship as well as commitment as partners relationally;

FIG. 5 is a diagrammatic view which illustrates the resultant relationship status (9, 10, 11 respectively) achieved through communication and appeal to the “three brains of Mr. Right” (4,5,6 respectively), and culminating in a woman achieving a committed, emotionally bonded, sexually attracted Partnership with a Bonded Friend and Lover in the one personage of “Mr. Right” (12), through the process of taking actions in the Attraction, Bonding in Friendship, and Commitment Phases in a sequence (17), which simultaneously takes the form of a story (16) of the woman's romantic relationship to the subject man;

FIG. 6 is a diagrammatic view which illustrates the resultant outcome of generating sexual attraction (9A) to the brainstem of Mr. Right (12), emotional attraction (10A) to the midbrain of Mr. Right (12) and intellectual attraction(11A) to Mr. Right (12) resulting in overall coupling with a Mr. Right (12) as an attracted lover, friend, and partner in one;

FIG. 7 is a diagrammatic view which illustrates the Attraction, Bonding, and Commitment Phases of relationship in terms of timecourse, where Attraction Phase on average lasts for up to one month, at which the beginnings of Commitment Phase may begin on average, and overlapped with the Bonding Phase of Friendship typically beginning as early as on the first date and as late as one month into relating, and reaching completion typically at approximately the three month mark of relating;

FIG. 8 is a diagrammatic view which illustrates the subject dating operating system, termed “the Three Brains of Mr. Right” as a system with design like a gasoline engine, where the “reptilian brain” causes “ignition” of the energy of the “mammalian brain” as a spark plug ignites gasoline, and the resultant reaction is contained in the bounds of the “higher brain,” where the relationship produces work or a product of joint effort;

FIG. 9 is a diagrammatic view which illustrates the attraction phase (13) where sexual attraction (9A) occurs to the man's brainstem (1) and describes its detail, showing that in each phase of the subject dating operating system that attention is simultaneously applied to the other two phases as well;

FIG. 10 is a diagrammatic view which illustrates the 3 Steps of the attraction phase (13), including display of beauty (18), demonstration of ability to raise “Alpha-male status,” (19) and creation of a contest (20) or set of tests for the male to pass or win;

FIG. 11 is a diagrammatic view which illustrates the 3 Steps of the Bonding Phase, including Mastery of Anger (21), via the Anger Map (FIG. 13) later depicted, Mastery of Anxiety (22) via the Anxiety Map (FIG. 14) later depicted, and mastery of matching personality type (23) and teamwork via the cognitive emotional spectrum map, wherein, since the subject dating operating system defines friendship between two persons as being mutually shared positive emotional energy on a consistent basis, the first two steps of the Bonding in Friendship Phase of the dating operating system necessitate the ability to master the two known uncomfortable emotions of anger, and anxiety, as in FIGS. 13 and 14, to produce positive emotional energy from all possible negative emotions, known to always be composed of a combination of anger and anxiety;

FIG. 12 is a diagrammatic view which illustrates the relationship between anger and sadness as an emotional extreme, with anxiety as an opposite emotional extreme, and as a spectrum, all possible negative emotions contained between as being composed of a geometric portion as anger, and the remaining amount as anxiety, concurrent with the transformation of such negative emotional energy to portions of positive emotional energy called self-esteem, and composed of well-being and confidence respectively, achieved through assertiveness and courage respectively;

FIG. 13 is a diagrammatic view which illustrates the detail of the anger and well-being end of the spectrum of emotional energy using an anger map, and how to transform the negative emotions of anger or depression into the component of self-esteem called well-being, a motherly, nurturing, positive energy;

FIG. 14 is a diagrammatic view which illustrates the detail of the anxiety and confidence end of the spectrum of emotional energy using an anxiety map, and how to transform the negative emotions of anxiety, or avoidance and impulsivity into the component of self-esteem called confidence, a “fatherly”, action-prone, positive energy, Psyche;

FIG. 15 is a diagrammatic view which illustrates the detail of the combined balance of the three internal psychological resources and their spectra in a way leading to “psychological integration”, the most efficient operation of the psyche or self, and the psychological state most likely and efficient at solving personal problems, producing durable fulfillment;

FIG. 16 is a diagrammatic view which illustrates the 3 steps of the Commitment Phase, including demonstration of Personal Boundary Function (24), joining beliefs toward common Life's Goals (25), and constructive decision-making in committing (26) to a durable relationship;

FIG. 17 is a diagrammatic view which illustrates the components of the personal boundary its diversity of function, repair and its contents;

FIG. 18 is a diagrammatic view which illustrates the components of two individuals engaged in “psychological commerce”;

FIG. 19 is a diagrammatic view which illustrates the detail of possible dynamics of a relationship between two individuals, in which the relative integration of the parts of the psyche can be beneficial, or detrimental to mutual growth, wherein the use of two joined personal boundaries in independence using boundary walls or codependence using boundary holes are considered immature, or destructive-win/lose (67), but interdependence is the only route to true durable commitment (105) via use of boundary doors (90), and considered mature, or constructive-win/win (66);

FIG. 20 is a diagrammatic view which illustrates the detailed spectral components of the operation of the intellectual data use resource, and how impairment of either type—left-brained education, or right-brained experience—leads to failure to reach a goal;

FIG. 21 is a diagrammatic view which illustrates how simultaneous and balanced use of the left-brained education and right-brained experience contributes to the reward of success in reaching a goal, and correcting the failure component of any given individual problem;

FIG. 22 is a diagrammatic view which illustrates the detailed spectral components of a decision-making operation within the decision-making resource;

FIG. 23 is a diagrammatic view which illustrates the detailed anatomy of a belief, a linking part between the Bonding in Friendship Phase and Commitment Phase of the Dating OS, intellectual function 38 within the Mind OS 31, and composed of the central idea within that belief (illustrated as a table top), supported by other ideas (illustrated as table legs), which are evidence that the idea of the belief is true, and attached to the representation of an individual's mind (illustrated as a floor) via quanta of emotional energy, wherein potential evidence both supporting and against the central idea of the belief are shown drifting past the top of the table, and wherein a numerous majority of an individual's beliefs are shown composing the summation of beliefs in an individual called an individual's “world view,” known as a “reality,” or “frame.”

### DETAILED DESCRIPTION OF THE INVENTION

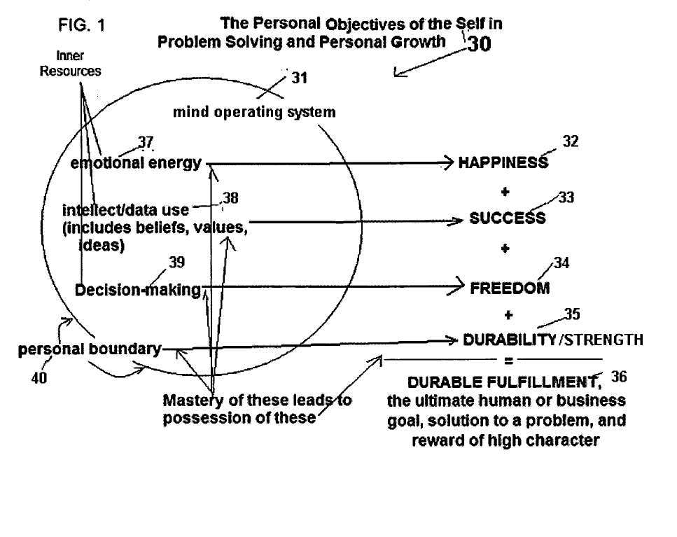

In FIGS. 1-23, a visual psychoanalysis system called the dating operating system, is used to help a user in forming, developing, and securing a relationship with another person and in solving problems involving human interaction.

The system comprises a series of visual illustrations, as shown in FIGS. 1-23, used to teach, coach and deliver therapy for personal growth, character growth, relationship analysis and corrective advice related to a relationship with another person including a male and a female, and in human groups and their behaviors including business settings.

The dynamic tool illustrations for relationship explorations and resolutions incorporate illustrations from the mind operating system.

In FIG. 1, the subject mind operating system is illustrated broadly using a general reference numeral 31. The mind operating system 31 includes a person's self 30 surrounded by a personal boundary, shown as a circle 40. Inside the person's self 30 are three psychological resources made up of emotional energy 37, ideas/beliefs/values called intellectual data use 38 and decision-making 39. By the mastery of emotional energy 37, intellectual data use 38, decision-making 39, and the personal boundary 40, one's self 30 is lead to the possession of happiness 32, success 33, freedom 34, and durability or strength 35. The acquisition of these latter four rewards adds up to durable fulfillment 36. Durable fulfillment 36 is found to be an ultimate desire of a person, individually and in relationships, and a core purpose in life. Also, durable fulfillment 36 is an ultimate solution to be sought to any psychological problem, conflict, trade, deal, negotiation, or other human problem related to science, economics, politics, sociology, or other social science application.

This drawing of the mind operating system 31 represents both a person's current status as to psychological state as well as his or her potential highest rewards for skill-building in acquiring the above mentioned four character components leading to durable fulfillment 36.

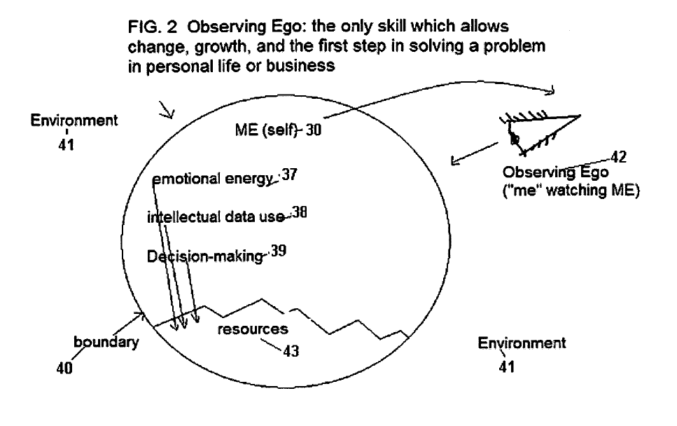

In FIG. 2, the mind operating system 31 is shown with an observing ego 42 viewing one's self 30 in order to solve any psychological problems and self-guide the building of romantic relationships and other relationships or human interactions. Also, the mind operating system 31 can be used to teach a person psychology.

The observing ego 42 is a human function and a teachable skill. This skill allows a person to change, grow psychologically and solve problems from a point of directing and controlling an outcome.

This drawing of the mind operating system 31 is an integrated way of naturally producing the observing ego 42, because it represents “you” and “your function” and therefore you can reflect on how you look at yourself. For example, FIG. 2 illustrates “you” looking at “you” as both an outside observer and also as a participant in your behavior at the same time. When one sees one's own psychological resources 43, and has become more “sentient” or “self-aware”, one sees the four cardinal working parts of the human psychology. These building blocks of psychology are one's personal boundary 40, which contains the three inner psychological resources 43: emotional energy 37, intellectual data use 38 and decision-making 39. Also, one begins to distinguish between one's self 30 and an environment 41 outside one's self. The environment is shown having general reference numeral 41 and represents an area outside of one's own personal boundary and which is not under the person's psychological or physical control. This space may include all things physical AND psychological, not in control of the self 30, which can also include the past and future events and conditions. To attempt to control the uncontrollable, e.g. the environment 41 is a state is called “suffering” 91: trying or wishing to control the uncontrollable.

The foundation illustrations for using the visual psychoanalysis system called the dating operating system utilize the imagery of the three brains of Mr. Right or alternately Ms. Right.

In FIG. 3, the basis for the a diagram of the three functional units of brain function, the reptilian brain 4, the mammalian brain 5, also termed emotional brain 5, and the higher brain 6 are depicted for an individual, and corresponding to the anatomical human brain divisions termed the brainstem 1, the midbrain 2, and the cortex 3 respectively. The overall function in subject mind operating system 31 of the three functional units, 4, 5, and 6 are listed in boxes to the right, with functional operations in subject dating operating system sequence 17 labeled respectively as sexual attraction 1A, emotional attraction 2A, and intellectual attraction 3A.

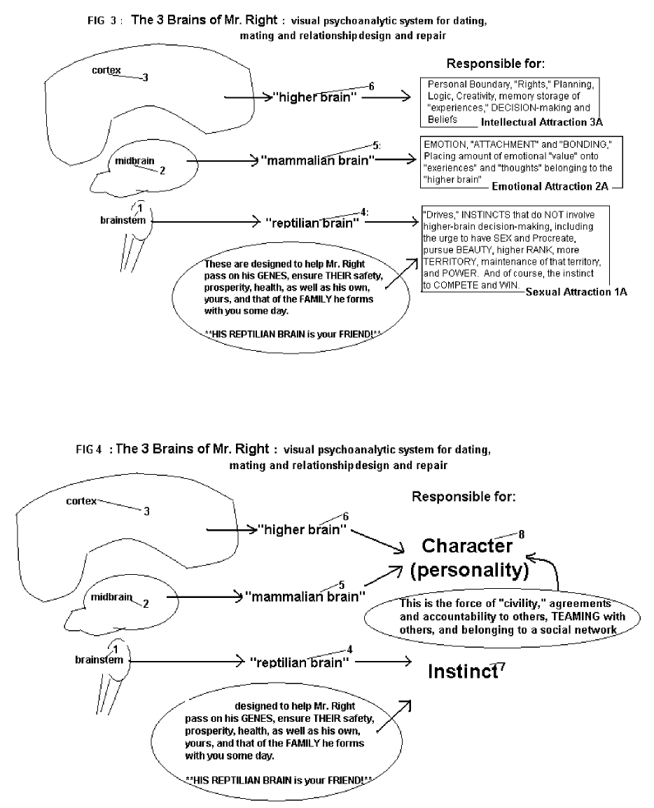

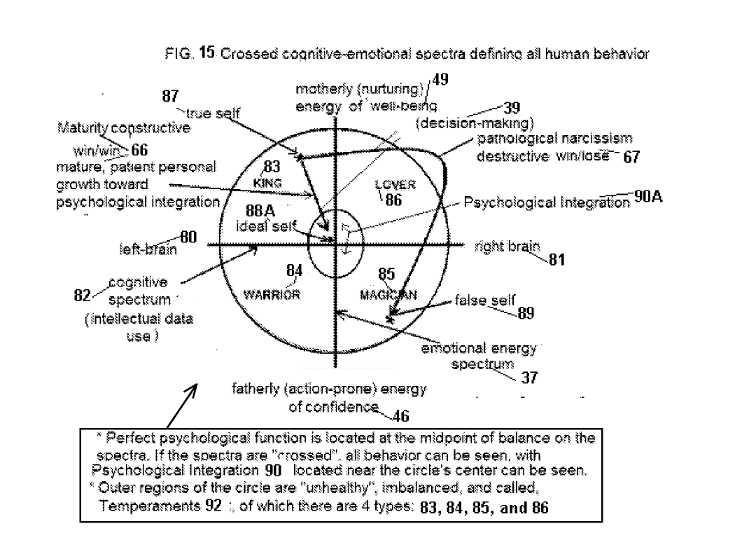

In FIG. 4, a diagram of the three functional units of brain function 4, 5, and 6 corresponding respectively in brain anatomy areas 1, 2, and 3, are further depicted as arranged into a function termed instinct 7, which is not alterable by individual 30 who owns it, but can be sexually attracted 1A by actions of an other 106, and a function termed character 8, also termed personality 8, which is alterable by an individual 30, and also can be emotionally attracted 2A and or intellectually attracted 3A by actions of an other 106. Character 8 or personality 8 is alterable by analysis and corrective action taken by an individual 30 via the subject mind operating system and its inherent KWML (King, Warrior, Magician, Lover) personality tool depicted in FIG. 15.

In FIG. 5, the system further comprises an illustration showing the three phases of a relationship corresponding to the three brains of Mr. Right or alternately of Ms. Right wherein the brainstem is responsible for instinct and therefore sexual attraction, and the midbrain combined with the cerebral cortex are responsible for the civilizing force of relationships called character to promote bonding in friendship as well as commitment as partners relationally. In FIG. 5 is depicted the overall subject system termed the dating operating system, known as the 3 brains problem-solving system, and comprised of three sequential 17 phases in order that must be applied by an individual courting another individual in a goal of establishing a durable romantic relationship. Said phases in order are depicted as follows: an attraction phase 13, in which sexual attraction 1A is stimulated in the brainstem 1 anatomically and reptilian brain 4 functionally of an other 106 by the self 30 to produce a lover 9, then in a bonding in friendship phase 14 in which emotional attraction 2A is stimulated in the midbrain 2 anatomically and mammalian brain 5, termed emotional brain 5 of an other 106 by the self 30 to produce a friend 10, then a commitment phase 15, in which intellectual attraction 3A is stimulated in the cortex 3 anatomically and higher brain 6 functionally of an other 106 by the self 30 to produce a partner 11. Friendship is termed in the subject dating operating system, “mutual and consistently positive emotional energy 51 shared by a self 30 and an other 106, not requiring commitment 105. It is recognized in subject dating operating system that surrounding and pervading the function of the sequence 17 of phases 13, 14, and 15 in order, that a mutual story 16 develops, serving self 30 and other 106 as a protection encouraging commitment 105, and guide to further action in correct timing within the sequence 17.

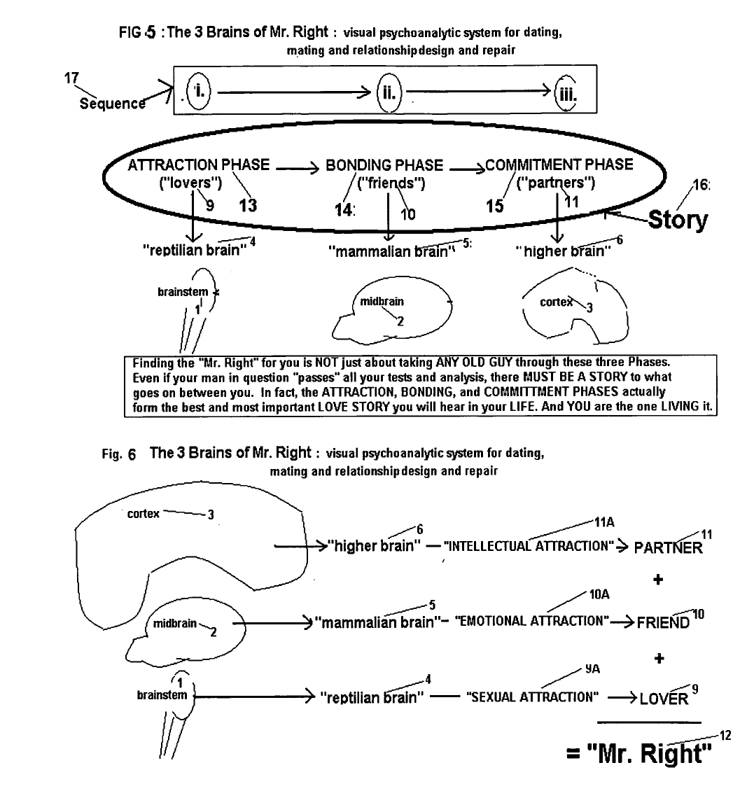

In FIG. 6, the system further comprises an illustration showing a user's actions in the attraction, bonding in friendship, and commitment phases in a sequence which takes the form of a story of the user's romantic relationship with a subject man, Mr. Right or alternately Ms. Right, to produce a resultant relationship status achieved through communication and appeal to the three brains of Mr. Right or alternately Ms. Right and culminating in the user achieving a committed, emotionally bonded, sexually attracted partnership with a bonded friend and lover in the one personage of Mr. Right or alternately Ms. Right. In FIG. 6, a diagram of the result of sequence 17 of application of subject dating operating system through attraction phase 13 employing sexual attraction 1A, bonding in friendship phase 14 employing emotional attraction 2A, and commitment phase 15 employing intellectual attraction 3A, resulting in specific functional status of the other 106 in the life of the individual 30 or self 30, as lover 9, friend 10 and partner 11 respectively, the collective functional status of which is termed in the subject dating operating system as Mr. Right 12 to a female individual 30 or self 30.

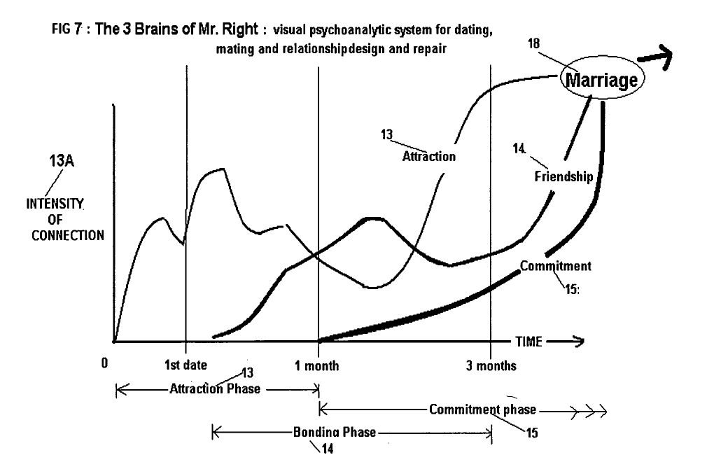

In FIG. 7, the system further comprises a diagrammatic illustration showing the intensity of connection over time of the attraction phase, the bonding phase, and the commitment phase of the relationship leading to a marriage at a culmination of the three phases. In FIG. 7, a diagram of the respective phases 13, 14, and 15 in sequence 17 is depicted in terms of timecourse of average onset and duration, and intensity of connection 13A of individual self 30 with other 106, and with attraction phase shown as onset at time zero of self 30 meeting other 106, and average transition to bonding in friendship phase 14 at one month duration, and with bonding in friendship phase 14 shown as onset on average at arbitrary time surrounding “first date” and complete with consistent or additive contact at approximately 3 months of consistent contact since first meeting, and with onset of commitment phase 15 at or after 1 month and continuing until termination of relationship or indefinitely, and required before the partner 11 status termed in subject dating operating system as marriage 18. In subject dating operating system, failure to complete a phase 13, 14, and or 15 in sequence 17, or in approximate time of average onset and or duration is considered to likely result in failure of the relationship to result in self 30 committing 105 to or finding Mr. Right 12, or to develop connection to the other 106 as a combination of lover 9, friend 10, and partner 11 in one other 106.

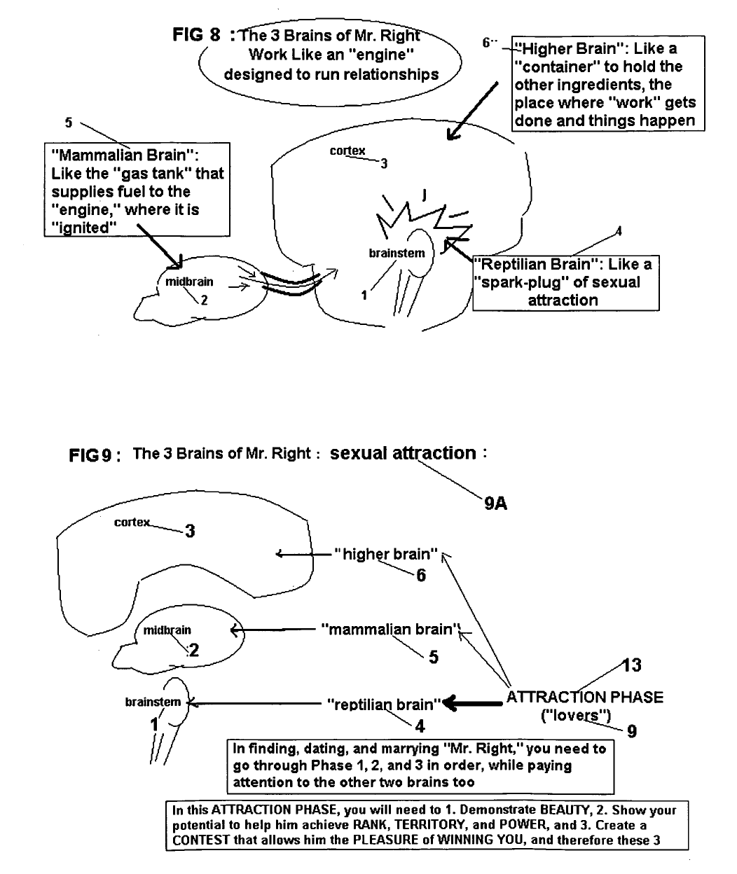

In FIG. 8, the system further comprises a diagrammatic illustration of the subject dating operating system, termed “the Three Brains of Mr. Right,” as a system with a design like a gasoline engine, where the “reptilian brain” causes “ignition” of the energy of the “mammalian brain” as a spark plug ignites gasoline, and the resultant reaction is contained in the bounds of the “higher brain,” where the relationship produces work or a product of joint effort. In FIG. 8, a diagram of a self 30 relating to an other 106 is depicted anatomically as 1, 2, and 3 and functionally as 4, 5, and 6 in relative similar function as that of a gasoline engine, with reptilian brain 4 operating as a spark plug, mammalian brain 5 known as emotional brain operating as a gasoline and oil tank, and higher brain 6 operating as the cavity of an engine. Functionally a relationship lacking the spark of sexual attraction 1A fails romantically, as does a relationship lacking the emotional energy 37 action-producing gasoline or soothing oil both of emotional attraction 2A fails romantically, as does a relationship lacking the containment and definition and harvesting of such action and ignition inherent in a personal boundary 40, intellect 38, and decision-making 39 within a higher brain 6 and via intellectual attraction 3A fails romantically. FIG. 8 then within subject dating operating system provides individual self 30 with a means of identifying weak points of individual's relationship likely to cause it to fail, directing individual to go to functions of subject dating operating system and mind operating system that produce corrective measures on the relationship system.

The series of visual illustrations of the present visual psychoanalysis system called the dating operating system comprises a series of relationship phase illustrations for the sequence and timing of three phases of a relationship, the series of relationship phase illustrations comprising: a first attraction phase 13, a bonding in friendship phase 14, and a commitment phase 15, as shown in FIG. 5.

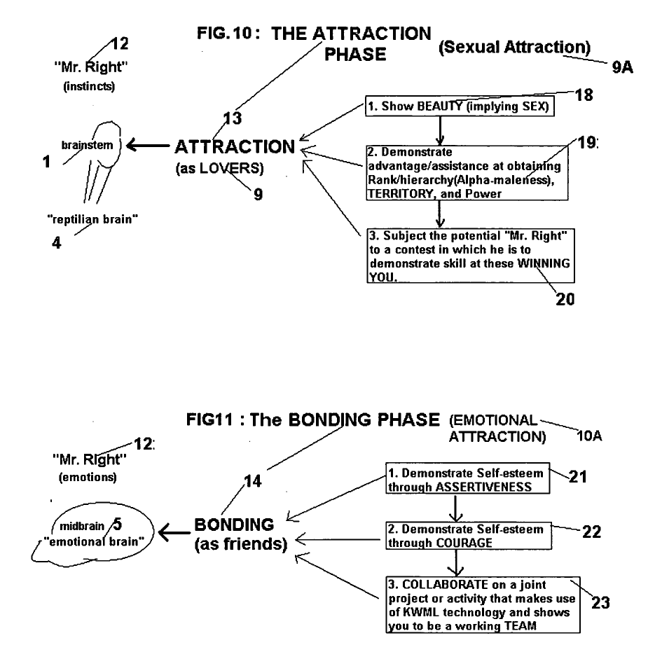

The first attraction phase of a relationship illustration 13, as shown in FIG. 5, is associated with a brainstem 1 as a reptilian portion of a brain 4. In The first attraction phase of a relationship illustration comprising three attraction steps including display of beauty 18, demonstration of ability to assist another person 19, and de facto production of status in the male of Alpha-male status which may include introduction of a contest for the desired other person to demonstrate skill at winning the user's affection 20, as shown in FIG. 10.

The first attraction phase 13 comprises at least one de facto production of status taken from the list of de facto producers of status including elevated rank societally in a hierarchy, elevated rank socially in a hierarchy, acquisition of physical territory, acquisition of social territory, acquisition of psychological territory, introduction of a contest of a person among others for attention of a user, introduction of a challenge of a person among others for attention of a user, and introduction of competition of the person among others for attention of a user.

In FIG. 9, the system further comprises a diagrammatic illustration of a series of details of the attraction phase wherein sexual attraction occurs to a person's brainstem and showing that attention is simultaneously applied to the other two phases as well. In FIG. 9, a diagram depicts the sexual attraction 9A operating within attraction phase 13 of subject dating operating system, with its three component steps in phase 1 of sequence 17 leading to other 106 entering functional status to the self 30 as lover 9.

In FIG. 10, the system further comprises a diagrammatic illustration of the three attraction steps of the attraction phase associated with the brainstem. The diagram depicts use of sexual attraction 1A in the attraction phase 13 of subject dating operating system for obtaining functional status in an other 106 by individual's self 30, as comprised of three steps in order, sequenced as display of beauty 18 to other 106, demonstration of assistance in obtaining or maintaining “alpha-male” status 19 for a male other 106, as rank or higher hierarchy, territory acquisition whether physical property, social influence, psychological space, and power, and finally, placing the male other 106 to a series of contests 20 or tests, of which one or more may be “playing hard to get” by self 30. The end of this i phase of sequence 17, the individual self 30 may move on to the bonding in friendship phase 14.

In FIG. 11, the system further comprises a diagrammatic illustration of the three bonding steps of the bonding phase associated with the midbrain. The second bonding in friendship phase of a relationship illustration 14 is associated with a midbrain 5 as a mammalian brain or emotional brain producing the emotions of Mr. Right 12 (or Ms. Right), as shown in FIG. 11. The bonding in friendship phase of a relationship illustration comprises three bonding steps including a demonstration of mature use of anger via assertiveness 21 to produce the positive emotion and self esteem termed well-being, a demonstration of mature use of anxiety via courage 22 to produce the positive emotion and self esteem termed confidence, and a demonstration of matching of temperament and personality 23 analyzed by and evidenced in productive joint teamwork on a project of mutual benefit to self and another, as shown in FIG. 11.

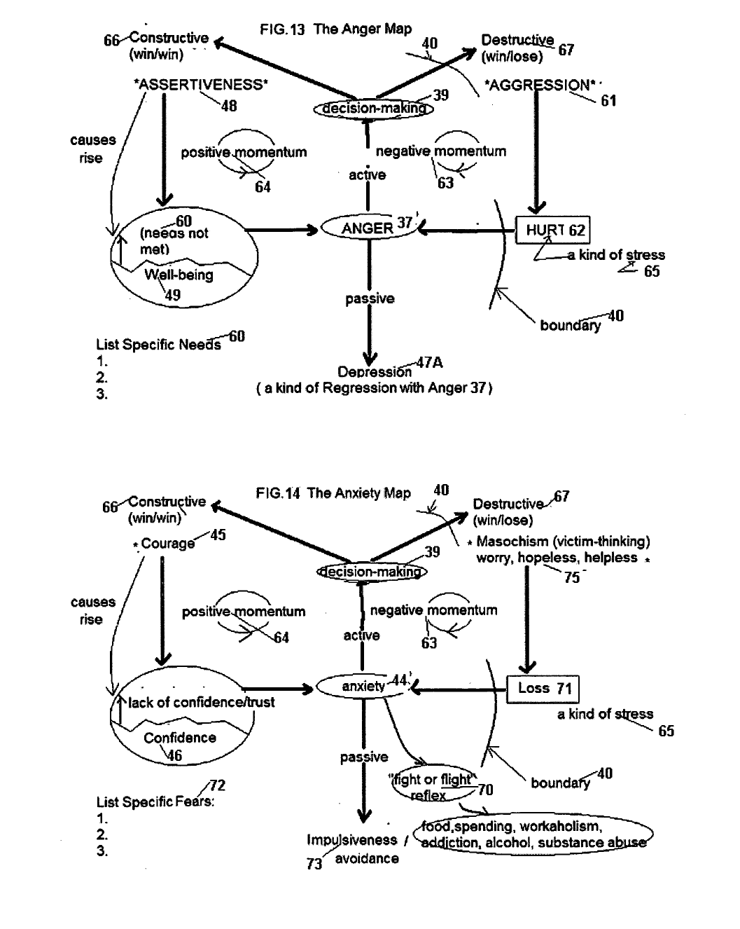

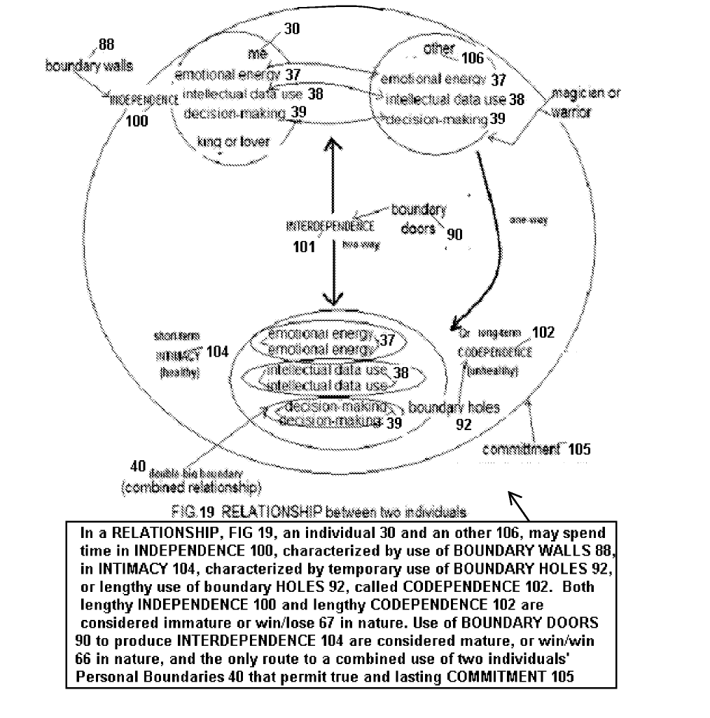

In FIG. 19, a diagram depicts the emotional attraction 2A steps by the individual self 30 done to a male or female other 106 in the process of facilitating functional status as a friend 10 in the other 106. The steps of the sequence, in order are “conveying maturity in use of anger through assertiveness” 21 defined in FIG. 13, “conveying maturity in use of anxiety through courage” 22 defined in FIG. 14, and demonstration of temperament and personality match through teamwork collaboration 23 on a joint project of effort. Step 3 (23) is illustrated in detail in FIG. 15 as far as personality match and opposites emotionally attracting 2A. Successful completion of the bonding in friendship phase 14 prepares the individual self 30 in developing a durable romantic relationship with other 106 via use of subject dating operating system to move on to the last phase of said system, termed the commitment phase 15.

In FIG. 1, a diagram of one of a person's three inner resources 43 inside the personal boundary 40 called emotional energy spectrum 37 is illustrated as a set of two spectrums of that resource. In the subject mind operating system 31, when a person is taught how to master the opposite ends of each spectrum, he or she can begin to master every permutation of the human emotional functions therebetween. When one masters the personal boundary 40, one finds more durability and strength 35, the first part of durable fulfillment 36, in solving a problem in a relationship or in life in general.

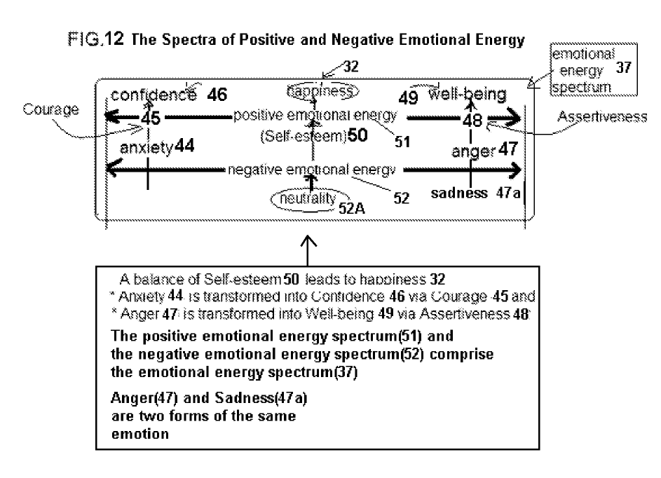

In FIG. 12, the system further comprises a diagrammatic illustration of a relationship between anger and sadness as an emotional extreme with anxiety as an opposite emotional extreme, and as a spectrum with all possible negative emotions contained between as being composed of a geometric portion as anger, and the remaining amount as anxiety, concurrent with the transformation of such negative emotional energy to portions of positive emotional energy called self-esteem, and composed of well-being and confidence respectively, achieved through assertiveness and courage respectively.

In FIG. 12, emotional energy 37 comes in two forms: negative emotional energy 52 and positive emotional energy 51, which is the same as self-esteem 50. The opposite ends of the spectrum of emotional energy 37 are anxiety 44 and anger 47 for negative emotional energy 52, and opposite ends are confidence 46 and well-being 49 for positive emotional energy 51. When a person reaches a balance on the spectrum of emotional energy 37 and between anxiety 44 and anger 47, he or she arrives at emotional neutrality 52A. However, positive emotional energies 51 of well-being 49 and confidence 46 are arrived at through mastering assertiveness 48 on the anger map and through mastering courage 45 on the anxiety map described later, respectively. A combination of well-being 49 and confidence 46 is called self-esteem 50, and an equal balance of well-being and confidence is termed happiness 32, the second part of durable fulfillment 36. Thus negative emotions are always some combination of anger and anxiety, which can be transformed to positive emotional 51 equivalents composing self-esteem 50, and if whose positive composition are set in balance equal happiness 32, a unique transformative process that ensures a durable friendship phase 14 of dating, mating sequence in humans, and guide to effective durable committed romantic or other partnership 11, and with friendship 10 defined in subject dating operating system as “mutual consistently shared positive emotional energy 51.”

In FIG. 13, the system further comprises a diagrammatic illustration of a detail of the anger and well-being end of the spectrum of emotional energy using an anger map, and a diagrammatic illustration of a transformation of the negative emotions of anger or depression into a component of self-esteem called well-being. FIG. 13 illustrates the detail of the anger and well-being end of the spectrum of emotional energy with an “anger map”, and how to transform the negative emotions of anger 37 or depression 47A into the component of self-esteem called well-being 49, a motherly, nurturing, positive emotional energy 51. The anger map of FIG. 13 details all interrelations between anger 37, depression 47A, hurt 62, the external manifestation of destructive anger, aggression 61, as well as the constructive 66 positive transformation of anger into well-being 49, via decision-making 39 to use anger in the form of assertiveness 48.

In the mind operating system 31, there are only two possible causes of anger 37. If hurt 62 manages to break into the boundary 40, via a boundary hole 92, it takes the form of anger 37. And inside the boundary, if one's needs 60 are not met, e.g. if there is a low level of the positive emotional energy 51 called well-being 49, then anger also arises.

Once an individual is in an angry state, the mind operating system describes only three possible uses or routes for anger:
1. Depression 47A, via passively letting anger store up inside, as if in a “tank”, which the personal boundary 40 does function as for an individual's internal psychological resources 43.
2. Aggression 61, via the impulsive, destructive 67 decision to impatiently let the anger out en masse in a win/lose way, attempting to hurt 62 another in a way that transfers the anger at them or into their boundary, therefore causing the original individual to “win” and the one receiving the anger to “lose”. This right circular arm of the anger map of FIG. 13 is called the “cycle of violence”, which generates negative momentum 67 for mutual personal growth.
3. Assertiveness 48, via the mature, constructive 66 decision to slowly, patiently use anger in a win/win way, in which one gets one's own needs 60 met independently of using or hurting others, and which may even benefit them as well. The left branch of this map shows that transformation of anger to well-being creates a cycle of positive momentum 64 for personal growth. The result of assertiveness 48 is a rise in one's well-being 49 level one hundred percent of the time, in a one-for-one proportion. This level may be measured in units and certain needs 60 may be listed on the part of an individual as being assigned a certain number of subjective units if they are met. In this way, the well-being which makes up half of self-esteem can be measured digitally. (Confidence 44 makes up the remainder of self-esteem in any given quantity of self-esteem).

Well-being 49, is the antidote for depression 47A, aggression 61 and criminality, and anger 37. In mastering assertiveness 48, an individual has mastered the anger end of the spectrum of negative emotional energy 52, by transforming that energy into a positive form 51, called well-being 49, which is one-half of what makes up one's total self-esteem, a synonym for happiness 32. It is therefore half of the final requirement for an individual to achieve durable fulfillment 36 in solving problems of relationships, establishing friendship based on positive emotion 51 and living life.

In FIG. 14, the system further comprises a diagrammatic illustration of a detail of the anxiety and confidence end of the spectrum of emotional energy using an anxiety map, and a diagrammatic illustration of transforming the negative emotions of anxiety, or avoidance and impulsivity into the component of self-esteem called confidence.

FIG. 14 illustrates the detail of the anxiety 44 and confidence 46 end of the spectrum of emotional energy 37, and how to transform the negative emotions of anxiety 44, avoidance and impulsivity 73 into the second and final component of self-esteem called confidence 46, a “fatherly”, action-prone, positive emotional energy 51.

The anxiety map of FIG. 14 delineates all possible interrelations of anxiety 44, impulsivity 73 and avoidance, victim-thinking, masochism 75 or martyr-like thinking, which includes forms of thinking the likes of includes but is not limited to “worry”, “complaining”, “helplessness”, “hopelessness”, “shame”, and other depressive or masochistic features of thinking. This cluster of terms and synonyms to them are the direct link between depression 47A and anxiety 44. Courage 45 is the transformer of the negative emotional energy 52 of anxiety 44 to the constructive form 66 in positive emotional energy 51 and its resultant reward, called confidence 46, which is the antidote for anxiety, masochism 75, impulsivity 73 and avoidance 73.

In the mind operating system 31, there are only two possible causes of anxiety 44. Either loss 71, a synonym for anxiety that is outside one's boundary and likened to a form of negative emotional energy 52 just as hurt 62 is, or else an internal lack of confidence 46 are the only causes of anxiety.

A lack of confidence 46 can be a general low amount of that second positive energy that composes self-esteem, or it can be specific lacks of confidence about specific fears 72 that can be listed by an individual in a journal, and therefore digitally measured as with one's needs 60 on the anger map. Hurt 62 and loss 71 are the two forms of negative emotional energy 52 which compose the general negative emotional energy 52 called stress 65 in the mind operating system 31.

In the mind operating system 31 there are also only three possible uses or outcomes of anxiety once it arises in the boundary 40:
1. Impulsivity 73 and avoidance are defined as “acting without thinking” produced when one is passive in one's use of anxiety, allowing it to take the instinctual course called the “fight or flight” reflex. This reflex uses one's anxiety in a healthy way when there is an immediate threat to life, but in an unhealthy way when there is not, in that event, promoting such behaviors, but not limited to them, as overeating, overspending, addictions, “workaholism”.
2. Masochistic 75, or victim-thinking are destructive 67 decisions to think with one's anxiety in a negative or pessimistic way that interacts with others in a win/lose way, dumping one's anxiety into the boundary of another, or trying to, and causing that other to suffer loss 71 of confidence 46 and the rise of anxiety 44. This cycle which occurs on the right of the map may be called the “cycle of self-victimization”, or “making a mountain out of a mole-hill”, which generates negative momentum 52 for one's life, as powered by the energy of anxiety 44. Such a cycle is only capable of generating more loss 71, anxiety 44, and masochism 75 energy, which cycles around indefinitely unless interrupted by the observing ego 42 enough to make a new kind of decision: a constructive 66 one called courage 45.
3. Courage 45, is the constructive 66 decision to “do the right thing, regardless of uncomfortable feelings”, and “doing the right thing” was previously described as being guided by one's conscience 122 and intuition 123. This means that since life is defined by a series of decisions, if one is alive, one can choose courage 45 as a decision at any time. One does not have to somehow find bravery or borrow some resource from others; courage 45 is only a decision, which any living being can elect to do. When courage 45 is done, the result is a rise in one's confidence 46 level one hundred percent of the time. This level can be measured in units assigned to the level of fear 72 of particular threats or problems originally listed before performing courage 45 on them, or on the perceived level of courage one estimates is required to overcome the fear 72. The left side of the map shows a positive emotional energy 51 cycle that creates positive momentum 64 in an individual's or couple's growth 99 in the bonding in friendship phase.

Anxiety 44 in the mind operating system 31 is then defined as a general negative emotional energy 52 state, but “fear” 72 is an amount of anxiety 44 coupled with the data particulars of a particular threat (or problem) or perceived threat.

Confidence 46 is the antidote for impulsivity 73 and avoidance, and addiction, masochism 75 and “victim mentality”, and anxiety 44. In mastering courage 45, an individual has mastered the anxiety end of the spectrum of negative emotional energy 52, by transforming that energy into a positive form, called confidence 46, which is the remainder (along with well-being 49) of what makes up one's total self-esteem, such that when well-being 49 and confidence 46 are present in one's self-esteem in equal amounts, one has happiness 32. It is therefore the other half of the final requirement for an individual to achieve durable fulfillment 36 in solving problems and living life.

When the individual has mastered the four components of the psyche that lead to the four parts of durable fulfillment 36 using the mind operating system, FIG. 15 illustrates detail of the combined balance of the resources 43 and their spectra in a way leading to “psychological integration”, the most efficient operation of the psyche or self, and which is the psychological state most likely and efficient at solving personal problems and producing ongoing durable fulfillment.

FIG. 15 shows a diagram with a circle that is different from the former use representing a boundary. In this drawing, the use of a circle with internally measured Cartesian coordinates provides a symbolic connection between the “imperfect and terrestrial” (Cartesian) with the goal of perfection and “impossible-to-reach” (the historically considered, perfect form of a circle). And so the unique form of this diagram demonstrates the imperfection of the human psyche as always at least slightly out of balance in its components, with the goal of striving toward the perfection of the psyche and its components in “psychological integration”. Within this circle are crossed axes of the spectra of both the intellectual data use 38 function, or “cognitive spectrum”, with the emotional energy 37 spectrum. The interior of the circle is then the field of all possibility of human individual or group behavior, now divided into four zones by these two axes termed “temperaments”. An individual's self 30 function, or psyche's function operates within the graphical and digitally measurable points within the circle.

The four zones of function are called “temperaments”, and an individual's temperament is defined in the mind operating system as a quadrant of intellectual-emotional function in which one characteristically spends the most psychological functional time.

The king temperament 83 is then left-brain 106 dominant and well-being 49 dominant, characterized by passive, nurturing, or need-meeting emotional energy, and may be called “motherly”, emotionally. In an analogous system of energy and its distribution such as an automobile, well-being 49 is to humans what “oil” is to an automobile.

The lover 86 temperament is then right-brain 107 dominant and well-being 49 dominant. The warrior 84 temperament is left-brain 106 dominant and confidence 46 dominant, characterized by action-prone emotional energy, and may be called “fatherly”, emotionally. The magician 85 temperament is right-brain 107 dominant and confidence 46 dominant. In an analogous system of energy and its distribution such as an automobile, confidence 41 is to humans what “gasoline” is to an automobile.

The trajectory of personal growth 120 may be tracked from immaturity and imbalance at the periphery of the circle, moving toward maturity and efficient balance of resource 43 use at the center of the circle, over the lifetime. The center contains “psychological integration” 90A, perfect function of the psyche, or self 30, which is impossible to achieve and maintain, but a goal to be strived for. As such, one's coordinates can be tracked in terms of the third internal resource of decision-making 39 too, also represented in a two-dimensional plane, by plotting the coordinates of three kinds of “self”: true self 87, false self 89, and ideal self 88A, which is the same as psychological integration, “perfect function of the psyche”.

The notion of these types of self, 87, 89, and 88A as points located on the Cartesian coordinate system diagram allows the three types of results of decision-making 39 to be represented along with the other two resources 43, called emotional energy 37 and intellectual data use 38, simultaneously. If the individual is passive, and allows regression 121 of growth, then true self 87 drifts to the periphery of the circle, into psychological imbalance and unhealthy. False self 89 is a state of self 30 associated with destructive 67 decisions, caused by lack or imbalance of either conscience 122 or intuition 123 and lack of observing ego 42. Ideal self 88A is a state of self 30 associated with constructive 66 decisions, characterized by adequate amounts and balance of conscience 122 and intuition 123, and by adequate observing ego 42 to clearly see that constructive 66 decisions are advantageous to self 30 and others.

When one makes a habit of destructive 67 decisions that are immature, or win/lose in nature of their psychological commerce with others, it is termed “pathological narcissism”. Suffering 91 is also a characteristic of pathological narcissism, indicating that immature boundaries, or boundary holes 92 are present, as one imagines being what is actually a false self 89, actually of the opposite temperament to one's true temperament. As such, the plotting of points to represent true self 87, false self 89, and ideal self 88A also economize the representation of personal boundary 40 function in the two-dimensional Cartesian coordinate system. False self 89 characteristically manifests through presence of personal boundary holes 92 and personal boundary walls 88, and true self 87 grows directly toward ideal self 88A through employing personal boundary doors 90 throughout life. As such, being imperfect, self 30 is always a combination of true self 87, false self 89, and ideal self 88A.

In the example depicted in FIG. 15, an individual of the king temperament 83, is pretending to be of the magician temperament 85. Pathological narcissism takes from the emotional energy 37 and time of others in order to “prop” oneself up with the illusion of psychological integration represented by the ideal self 88A.

If one standing in true self 87 were to look out on the plane of the diagram, across the center, the vision of false self 89 would “appear” as if it were at the center, where total psychological health and optimal function of the psyche are represented. However, the role of observing ego 42 is such that one may “step out of the diagram” to look back on one's self from a literally higher perspective (and an added, third dimension) to see that the most healthy, constructive 66, win/win approach toward one's ideal self 88A is to autonomously do the work on self 30 from one's own starting temperament, working in a win/win constructive 66 way that leads to real growth 120 toward psychological integration that is represented in the ideal self 88A.

Suffering 91 (as shown in FIG. 17) manifests pathological narcissism in the form of aggression 61 (as shown in FIG. 13) and masochism 75 (as shown in FIG. 14) are necessary to steal the energies of well-being 49 (FIG. 13) and confidence 46 (FIG. 14) from others 106 (as shown in FIG. 19) against their free will 39, in order to maintain the illusory but high-energy state called false self 89 (as shown in FIG. 15).

Since suffering 91 is a boundary 40 effect (as shown in FIG. 17), and the decision-making 39 features of destructiveness 67 and constructiveness 66 are now also represented in the diagram of FIG. 14, all four components of the psyche can be represented on one two-dimensional diagram with simultaneous function represented by a single point in space at the true self 87, shown in FIG. 15. And through observing ego 42 of FIG. 2, which takes one out of the current “plane” of self-awareness to a higher perspective, and literally higher dimension of understanding, an individual can clearly see both the current unhealthy projection of that point at false self 89, and the recommended alternative future projection of that point in ideal self 88A, as shown in FIG. 15.

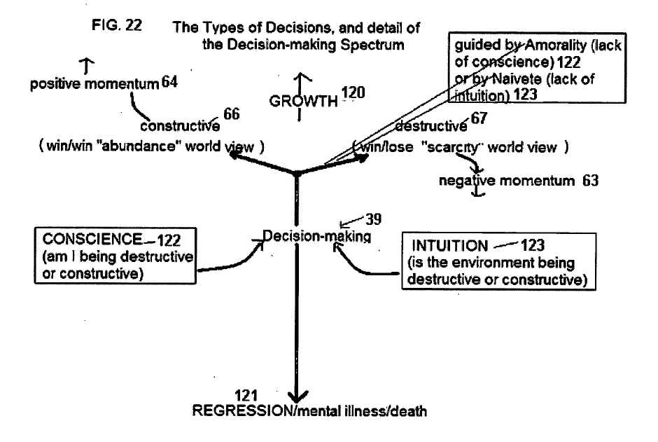

Thus personal growth 120, as shown in FIG. 22, and problem-solving can be enacted both by seeing what the individual is doing wrong, and what they could instead do right. FIG. 15 then provides a graphical, digitally measurable way of representing not just individual function of components of the psyche, but all of them simultaneously.

When two individuals combine psychological resources 43, the outcome can be promoting of both of their growth 120 and problem-solving, or else detrimental ending the prospect of a durable relationship at the bonding in friendship phase 14 of subject dating operating system, prior to attempting the commitment phase 15.

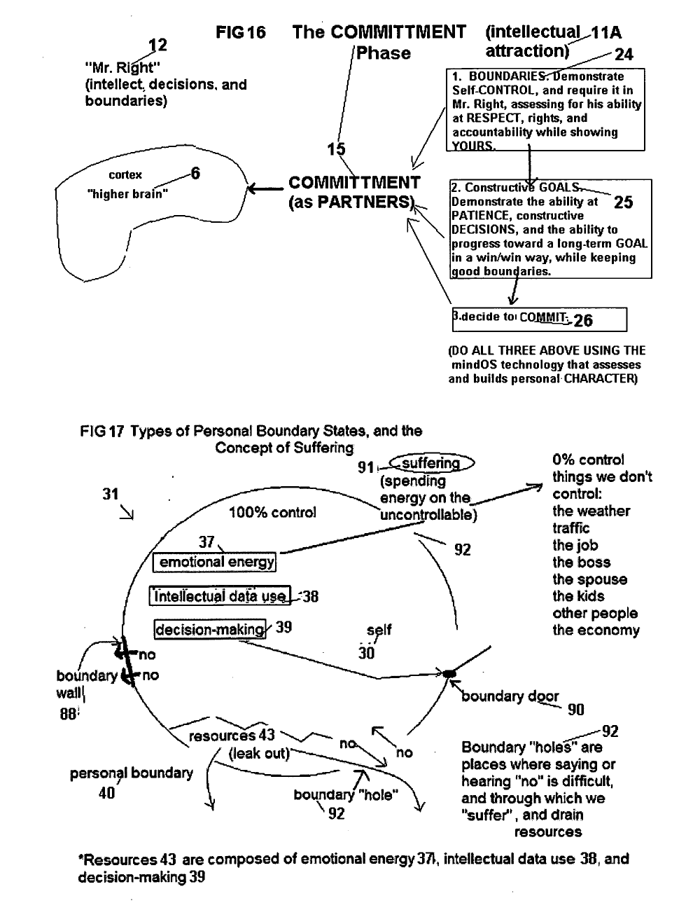

The third commitment phase illustration 15 of FIG. 16 is associated with a cerebral cortex representing a higher brain 6 for intellect, decisions, and boundaries used by Mr. Right 12 (or Ms. Right). The commitment phase illustration comprises three commitment steps: a demonstration of mature personal boundary use 24, a mature intellectual function use toward joint life's goals between self and an other 25, and a constructive and mature decision making ability in self and other resulting in a decision to commit to one another 26, as shown in FIG. 16.

In FIG. 19, a diagram depicts the final phase of development of a durable romantic or other relationship between an individual self 30 and other 106 in subject dating operating system, termed the commitment phase 15 of FIG. 16.

In FIG. 16, the commitment phase 15 is a sequential set of three steps in which the individual demonstrates mature personal boundary function as a first commitment step 24 and which is inherent in the analysis and correction of function of a personal boundary 40 by the subject mind operating system 31, a second commitment step 25 in which the individual demonstrates functional ability to move jointly with other 106 toward a set of mutual life's goals 25 effectively and with patience and use of intellectual data use spectrum 38, and finally a third commitment step 26 that demonstrates constructive 66 use of decision function 39 and commitment 105, as shown in FIG. 19.

In FIG. 17, the system comprises a diagrammatic illustration of the detail of possible dynamics of a relationship between two individuals, in which the relative integration of the parts of the psyche can be beneficial or detrimental to mutual growth, wherein the use of two joined personal boundaries in independence using boundary walls or codependence using boundary holes are considered immature, or destructive-win/lose, and interdependence is the only route to true durable commitment via use of boundary doors, and considered a mature, constructive-win/win relationship.

In FIG. 17, Step one of the commitment phase 15 in a relationship, the components of the personal boundary 40 are shown where holes 92 in the boundary are defined as areas of life, situations or entities to which the person has difficulty “saying no” to, or “hearing no” from. The holes 92 in the boundary allow an individual to undergo “suffering”. Suffering 91 is defined as “spending the currencies of time, freedom or energy, trying or wishing to control the uncontrollable”.

Holes 92 in the boundary are shown to be repaired by mastering facility at “saying no” and “hearing no”, tolerating rejection. Boundary walls 88 are places where the individual always says “no” to potential psychological commerce, allowing no new information, decisions or energy in, and seeking no new goals. Such a person becomes lonely or is starving for new energy or information eventually. Boundary doors 90 are linked to a decision-making process to open them, and are best opened to constructive, win/win commerce and closed to destructive, win/lose commerce.

In FIG. 17, in the place of holes 92 or walls 88 in the boundary 40 (areas of life where one only says no to new opportunity and is not open to compromise), both conditions of which are psychologically immature, an individual learns to master placing doors 90 in one's own boundary 40.

The function of doors 90 in the boundary are a combination of the function of personal boundary 40 function and decision-making 39 function, in which the individual learns to open the boundary to constructive 66 commerce from the outside world, and close the boundary to destructive 67 commerce. Constructiveness 66 promotes more of the psychological currency called freedom 34, the second requirement for an individual to achieve durable fulfillment 36, and using doors 90 in the boundary, which eliminate suffering 91, instead of holes 92 or walls 88 in the boundary 40, leads to durability 35, the first requirement for an individual to achieve durable fulfillment 36 in a committed relationship or individual.

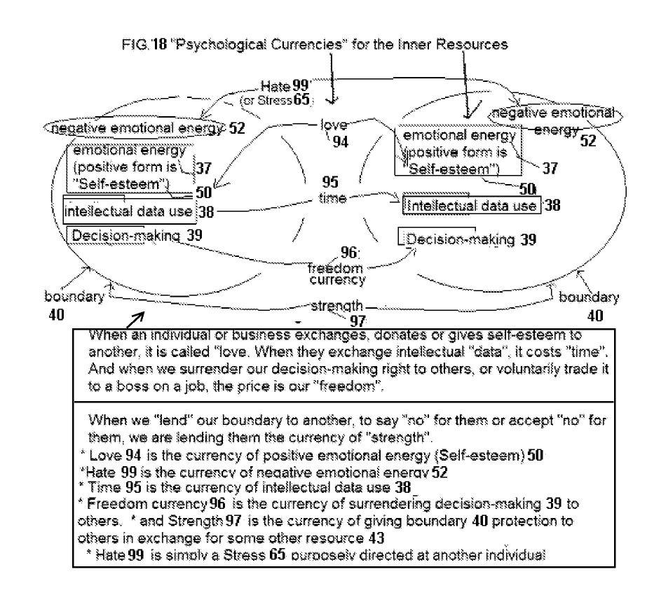

In FIG. 18, the system further comprises a diagrammatic illustration of the components of the subject mind operating system of two individuals engaged in psychological commerce related to relationship forming. FIG. 18 illustrates the components of two individuals engaged in “psychological commerce”, also supporting success 33 in demonstrating maturity of personal boundary 40 function, the first step 24 in the commitment phase 15 of subject dating operating system, in which the three internal resources 43 are “traded” with each other in the form of “psychological currency”, the currency for the positive emotional energy 51 resource, termed “love” 94, for the negative emotional energy 52 in us, termed hate 99, an intentional inflicting of stress 65 on others. Currency for the intellectual resource is termed “time” 95, the currency for the decision-making resource termed “freedom” 96 for a couple, or 34 for an individual, and currency of lending one's boundary termed “strength” 97 for a couple, or 35 for an individual.

The brain stem, midbrain, and cerebral cortex together comprise the three brains of Mr. Right and alternately the three brains of Ms. Right, an ideal mate for a user of the system, the three brains corresponding to the three phases of the relationship.

In FIGS. 12-15, 17, and 19-22, visual illustrations of recommended remedies for faults inherent in relationships are used.

In FIG. 15, the bonding in friendship illustration for demonstration of matching of temperament and personality evidenced in productive joint teamwork on a project of mutual benefit to self and an other comprises a four quadrant diagrammed illustration with a horizontal cognitive spectrum axis and an intersecting vertical emotional energy spectrum dividing a circle into four quadrants representing King, Warrior, Magician, and Lover (KWML) as a diagrammed illustration used as a tool of a subject mind operating system including an illustration of an observing ego outside of the circle looking into the circle. The horizontal cognitive spectrum axis and the intersecting vertical emotional energy spectrum divide a circle into four quadrants representing King, Warrior, Magician, and Lover as a diagrammed illustration defining all human behavior and further comprising a detail of the combined balance of the three internal psychological resources and their spectra in a way leading to psychological integration, the most efficient operation of the psyche or self, and the psychological state most likely and efficient at solving personal problems, producing durable fulfillment.

The subject mind operating system further comprises an illustration of four psychological and individual character building blocks comprising emotional energy leading to happiness; intellect including beliefs, values, and ideas leading to success; decision-making leading to freedom; and personal boundary leading to durability and strength, mastery of the four building blocks combining to produce a desired goal of durable fulfillment.

The system further comprises a diagrammatic illustration of the components of the personal boundary showing diversity of function, repair, and contents of the personal boundary in conjunction with the emotional energy, intellectual data use, and decision-making of the subject mind operating system and an associated concept of suffering.

FIG. 19 illustrates the detail of possible dynamics of a relationship between two individuals, further supporting success 33 in demonstrating mature personal boundary 40 function in step one 24 of the commitment phase 15 of subject dating operating system, in which the boundaries of the self 30 and other 106 can be in a state of independence 100 or time-limited intimacy 104, which are both psychologically healthy when combined in interdependence 101. However, when boundaries 40 combine interminably, the condition of the relationship is called codependence 102. Around the entire dynamic system in a mature, healthy relationship is a “group boundary”, termed commitment 105.

If one individual 30 happens to be generally of a king 83 temperament and the other person 106 one is relating to happens to also be of a king temperament 83, then pathological narcissism, or relational destructiveness 67 is easy to rise between them, leading to codependence 102. However, if the pair are opposite in temperament, e.g. a king-temperamented 83 person with a magician-temperamented 85 person, or a warrior temperamented 84 person with a lover-temperamented 86 person, the resultant stability of the system promotes mutual mature psychological growth 120 due to possession of all four desired temperamental functions 83, 84, 85, and 86 respectively, between them, creating the possibility of joint, assisted mastery of all four core components of the psyche. Interdependence 101 in their relationship then becomes both the ongoing goal of their relational state, a new empowerment of personal growth 120 by virtue of two individuals' joint efforts at growth 120, and the higher likelihood of occurrence than codependence 102.

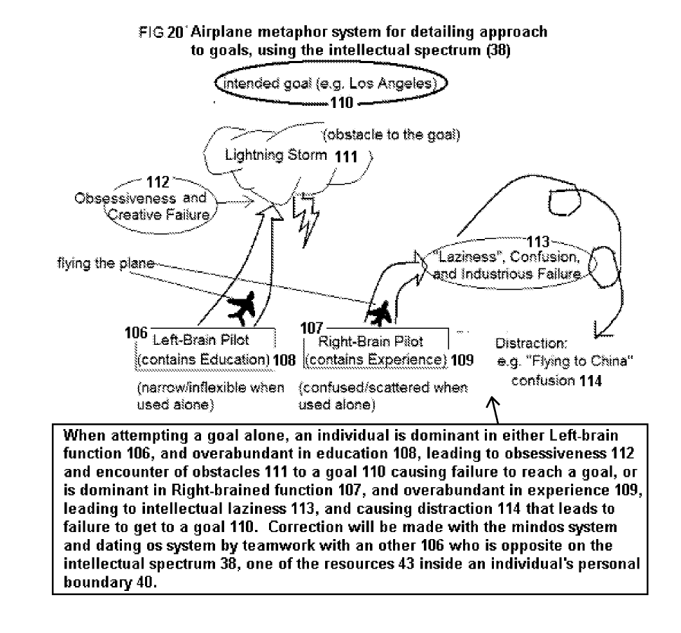

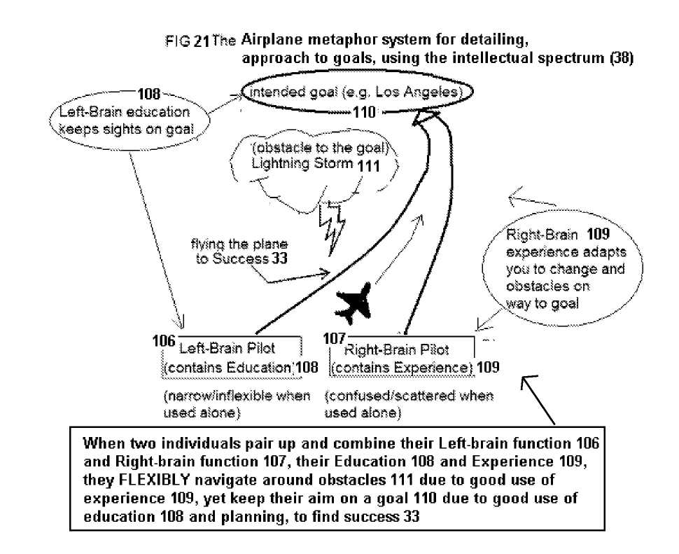

In FIG. 20, the system further comprises a diagrammatic illustration of detailed spectral components of the operation of the intellectual data use resource of the subject mind operating system showing how impairment left-brained education used alone as illustrated by a left brain pilot of a plane leads to obsessiveness and creative failure illustrated by the plane flying into a lightning storm, and how right-brained experience used alone illustrated by a right-brain pilot leads to laziness, confusion, and industrious failure to reach a goal illustrated by flying in a wrong direction.

FIG. 20 illustrates the detailed spectral components of the operation of the intellectual data use 38 resource, divided into “left-brain” 106 function that is like a data “tank”, “filled” with education 108 on one end of the intellectual data use spectrum, and “right-brain” 107 function that is like a data “tank”, “filled” with experience 109 on the other end of the intellectual data use spectrum. Such use by individual self 30 and other 106 demonstrates success 33 of self 30 and other 106 in completing demonstration of success at moving toward mutual life's goals, with patience and efficient mutual intellectual function, which is step two 25 of the commitment phase 15 of subject dating operating system. The metaphor of flying an airplane is used graphically to represent this function, with the left-brain 106 function acting as pilot on one attempt at a goal 110, and the right-brain 107 function acting as a pilot on another attempt at a goal 110. Impairment in function of either end of the intellectual data use spectrum, in left-brained education 106, producing confusion 113, laziness, or industrious failure by default, or right-brained experience 109, producing obsession 112 or creative failure by default, causes failure to reach a goal 10.

When one's left-brained education is not balanced with enough right-brained, creative, artistic, flexibly-used experience, a creative failure (or obsessiveness 112) is the result, in which the individual tends to run up against obstacles 111 to a goal 110, repeatedly failing to get around or overcome them. When one's right-brained experience is not balanced with enough left-brained, logical, orderly, detail-oriented education, an industrious failure (or confusion 113) is the result, in which the individual loses track of the original goal 110 and becomes “lost” on the way to that goal.

The opposite ends of the spectrum of intellectual data use 38 are the right-brained experience 109 and the left-brained education 108. When the person adds to the mind's left-brain 106 with the logical, organized, historic data called education 108, and adds to the mind's right-brain with the creative, flexible, artistic future-oriented data called experience 109, he or she reaches a balance of intellectual data use in the mind operating system, which leads to success 33, the third part of durable fulfillment, via balance of education 108, also termed “book smarts”, and experience 109, also termed “street smarts” in teaching and employing the mind operating system.

In FIG. 21, the system further comprises a diagrammatic illustration of detailed spectral components of the operation of the intellectual data use resource of the subject mind operating system showing how simultaneous and balanced use of left-brained education and right-brained experience, illustrated by a combined left-brain and right-brain pilot flying a plane, contributes to the reward of success in reaching a goal illustrated by flying to a desired location, and correcting the failure component of any given individual problem.

FIG. 21 supporting step two 25 of commitment phase 15 of subject dating operating system, illustrates how left-brained education 108 causes a couple to remain focused on a goal 110, contributing to success 33, and right-brained experience 109 causes the individual to be flexible for getting around obstacles 111 on the way to a goal 110, also contributing to success 33, which is the third requirement to have achieved durable fulfillment 36. The airplane metaphor in this example serves to show both left-brain 106 function and right-brain 107 function working in synchrony, as “copilots”. The result is smooth approach around obstacles 111 to reach a goal 110.

In FIG. 22, the system further comprises a diagrammatic illustration of detailed spectral components of a decision-making operation within the decision-making resource of the intellectual data use resource of the subject mind operating system, showing decision making leading to positive momentum with a constructive win/win abundance world view and alternately to negative momentum with a destructive win/lose world view, and alternately regression rather than momentum leading to mental illness and death.

FIG. 22 illustrates the detailed spectral components of a decision-making operation within the decision-making 39 resource, where conscience 122 and intuition 123 contribute before a decision is made, which when applied to commitment 105 of self 30 and other 106, which is Mr. Right 12 at completion of this step, constitutes step three 26 of the commitment phase 15 of subject dating operating system. Conscience 122 is a sense that informs one that his internal motives for a decision are either constructive 66 or destructive 67. Intuition 123 is a sense that informs one that the current environment 41 of choice is either constructive 66 or destructive 67 toward his health, safety, sought-after goals, ambitions or general welfare.

One possible end result of a potential decision is that it can be passive (no decision) which produces a quick decline in overall self 30 function, termed regression 121, which if continued interminably can lead to illness and even death.

A second possible result of a decision is that it destructively 67 produces negative momentum 63 for one's growth 120 through being win/lose in behavior or thought, and seeing the environment as a place of scarcity. This indicates a childish or immature choice for decision-making 39. Destructiveness 67 is produced by amorality (lack of conscience) 122, or by naivete (lack of intuition) 123, and is characterized by being weak in observing ego 42 skill. If destructiveness 67 approaches from the environment, one should “close” the personal boundary door 90 to it.

Third and finally, the last possible result of a decision is that it constructively 66 produces positive momentum 64 for one's growth 120 through being win/win 66 in behavior, seeing the environment as an abundant place. Constructiveness 66 and resultant positive momentum 64 for personal growth 120 are facilitated by high observing ego 42 skill at seeing the high-probability benefits of constructiveness 66, which carries with it mature traits such as patience, delayed gratification, teamwork, and cooperative leadership. If constructiveness approaches from the environment, one should “open” the personal boundary door 90 to it.

Since biologists define “life” as an “entity with decision-making power”, making any decision makes an individual grow and feel “more alive and free”, and making no decision at all causes an individual cease to grow and feel “less alive”. FIG. 22 represents all possible general outcomes of a decision to be made: regression 121 (passive, no decision), destructive 67 producing negative momentum 63, or constructive 66 producing positive momentum 64. If the outcome of a decision is not either at least a small portion constructive or destructive, then it wasn't a decision.

The opposite ends of the spectrum of the third resource or the making of decisions 39, or a person's will, are intuition 123 and conscience 122. When the person reaches a balance between intuition and conscience, then he or she can go forward with wisdom, an equal balance of intuition 123 and conscience 122 in the making of an informed decision, which leads to society granting the individual more freedom 34, the fourth and final part of durable fulfillment 36 in an individual 30 or relationship.

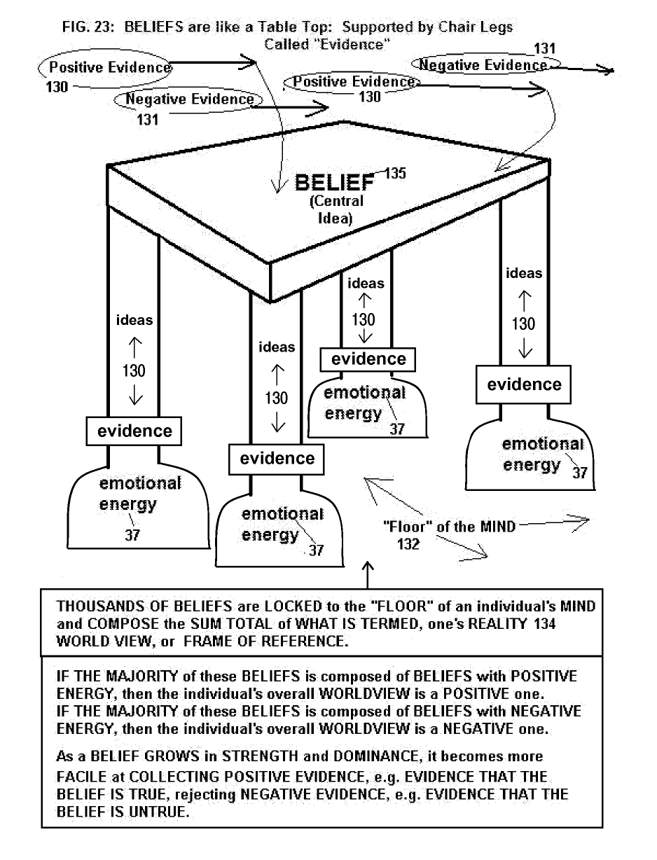

In FIG. 23 the system further comprises a diagrammatic illustration of a detailed anatomy of a belief, a linking part between the bonding in friendship phase and the commitment phase of the dating operating system associated with intellectual function within the mind operating system, and composed of the central idea within the belief illustrated as a table top, supported by other ideas illustrated as table legs, which are evidence that the idea of the belief is true, and attached to the representation of an individual's mind illustrated as a floor via quanta of emotional energy, wherein potential evidence both supporting and against the central idea of the belief are shown drifting past the top of the table, and wherein a numerous majority of an individual's beliefs are shown composing the summation of beliefs in an individual called an individual's world view, known as a reality or frame.

FIG. 23 illustrates a diagram of a belief 135 within a belief system, termed worldview 134, and termed frame, and reality, which forms a bridge between function of the mammalian brain 5 and higher brain 6 of an individual, and therefore mastery of which is also a bridge between phases of bonding in friendship 14 and commitment 15 of subject dating operating system. In subject dating operating system, the function of the mammalian brain 5 in anatomical form as midbrain 2 consists of storing emotional energy 37, releasing emotional energy 37, and attaching said energy to ideas 130 which reside functionally in the higher brain 6 and anatomically in the cortex 3, linking the function of the mammalian brain 5 termed also emotional brain, with the function of the higher brain 6, and establishing emotional value or valence be assigned to particular items of data, ideas 130, regarding events, individuals, concepts, and other data, to support and produce beliefs with one central idea 135. Beliefs 135 that amass in total in attachment to the functional “floor of the mind” 132 constitute worldview 134, termed also reality, and frame of reference, or frame.

In the subject dating operating system is defined a function within friendship 10 that a self 30 and other 106 assign individual valuations to individual aspects of each other, and overall in total of each other, via the emotional amount, value or valence of emotional energy 37 whether positive emotional energy 51 or negative emotional energy 52, and in which a majority of negative emotional energy 52 attached to the valuation of another individual in a relationship results in the functional condition of failure to be a friend 10, due to the condition established in subject dating operating system that a friendship 10 consist of “mutual and consistently shared positive emotional energy 51.” Within the higher brain 6, and in the commitment phase 15 of the subject dating operating system, step two 25, a required action toward a durable romantic or other relationship is that two individuals work with patience toward joint mutual life's goals. A majority negative emotional energy 52 valence to any individual's belief system depicted in FIG. 23 results in a failure to progress in the commitment phase 15 of subject dating operating system.

The system visual illustrations may be presented via any medium including at least one presentation medium taken from the list of presentation mediums including a book, a booklet, a pamphlet, a loose-leaf binder, a paper based medium, a synthetic sheet based medium, a mailer, a poster, an electronic book, a computer file, a computer software program, a program presented on the world wide web, a web site, a television program, a digital recording medium, a magnetic storage medium, a photographic medium, an electronic mail medium, a projection medium, a slide, a film, a microfilm, an overhead projection medium.

In use, the observing ego represents a person viewing oneself enabling a person to utilize the present system. With a mastery of the personal boundary, emotional energy, intellectual data use and decision-making, the person is led to the rewards of durability, happiness, success and freedom. A user progresses through he present system of psychoanalysis using a visual psychoanalytic unification system using visual and geometric diagrams for devising an effective personal dating process, human mating sequence, and human mood, failure, and relationship analysis and problem solving.

The visual psychoanalysis method called the dating operating system, is used to help a user in forming, developing, and securing a relationship with another person and in solving problems involving human interaction. The method comprises:

using a series of visual illustrations to teach, coach and deliver therapy for personal growth, character growth, relationship analysis and corrective advice related to a relationship with another person including a male and a female, and in human groups and their behaviors, using the series of visual illustrations comprising;

using a series of relationship phase illustrations for the sequence and timing of three phases of a relationship, using the series of relationship phase illustrations comprising:

using a first attraction phase of a relationship illustration associated with a brainstem as a reptilian portion of a male brain, the first attraction phase of a relationship illustration comprising three attraction steps including display of beauty, demonstration of ability to assist a person, and de facto production of status in the male of Alpha-male status;

using a second bonding in friendship phase of a relationship illustration associated with a midbrain as a mammalian brain, the bonding in friendship phase of a relationship illustration comprising three bonding steps including a demonstration of mature use of anger via assertiveness to produce the positive emotion and self esteem termed well-being, a demonstration of mature use of anxiety via courage to produce the positive emotion and self esteem termed confidence, and a demonstration of matching of temperament and personality analyzed by and evidenced in productive joint teamwork on a project of mutual benefit to self and another; and

using a third commitment phase illustration associated with a cerebral cortex representing a higher brain, the commitment phase illustration comprising three commitment steps: a demonstration of mature personal boundary use, a mature intellectual function use toward joint life's goals between self and an other, and a constructive and mature decision making ability in self and other resulting in a decision to commit to one another;

using a combined illustration of the brain stem, midbrain, an cerebral cortex together comprising the three brains of Mr. Right and alternately the three brains of Ms. Right, an ideal mate for a user of the system; and

using at least one visual illustration of recommended remedies for faults inherent in relationships.

The visual psychoanalytic unification system is designed to teach, coach and deliver therapy for personal growth, character growth, relationship analysis and corrective advice and called “Mind OS”, “mind operating system,” and its specific use as a system of analysis of dating, mating sequence and relationship analysis is termed “Dating OS,” or “dating operating system,” called “the 3 brains problem-solving system.” The subject mind operating system has incorporated within it, an original system of personality identification and treatment called “KWML” (King, Warrior, Magician, Lover).

The user's mastering these four character components and the ends of their spectra of function leads the user to solutions to any personal problem involving psychology, and to durable fulfillment, which is a summation of durability, happiness, success and freedom. Also the illustrations of emotional energy is shown as an emotional energy spectrum, including a negative emotional energy spectrum and a position emotional energy spectrum, the intellectual data use shown as an intellectual data use spectrum and decision-making shown as a decision-making spectrum.

The dating operating system which includes three “brains” as symbolic of functional strategies that must be undergone by a user in the human mating sequence include an Attraction Phase, followed by a Bonding in Friendship Phase, followed by a Commitment Phase.

The Attraction Phase includes a communication and appeal by a user to a another person's brainstem/“reptilian brain” sexual attraction mechanism, via display of beauty, followed by demonstration of ability to elevate a man's Rank, Territory, or Power (“Alpha-male status”), followed by the creation of a contest for the person to win the user's attention against others, or over the user's testing that impedes sexual advance.

The Bonding in Friendship Phase includes a communication and appeal by a user to a another person's midbrain/“mammalian brain” emotional attraction mechanism, via demonstration of mastery of anger use, followed by mastery of anxiety use and followed by mastery of personality match in friendship proving effective teamwork collaboration.

The Commitment Phase includes a communication, decision, and effort by a user to another person's cerebral cortex/“Higher brain” intellectual attraction mechanism, via demonstration of mastery of Personal Boundary use, mastery of joining belief systems toward mutual Life's Goals, and mastery of constructive decision-making to commit to a contract of exclusivity with a partner, completing a process of building a relationship with a sexually-attracted Lover in bonded Friendship, as a committed Partner, which in the context of a unique, shared story, comprises what is defined in said dating operating system is called “Mr. Right” or alternately “Ms. Right”.

The present method of visual psychoanalysis, the visual method used to help a person view and master four parts of a human psyche, dating, a human mating sequence, and relationship analysis and corrective measure function, comprises:

drawing a circle for illustrating a personal boundary, said personal boundary representing a surrounding of a person's self;

illustrating a person's emotional energy and shown inside the circle;

illustrating a person's intellectual data use and shown inside the circle;

illustrating a person's decision-making and shown inside the circle; and

illustrating three sequential phases of courtship in an attraction phase, a bonding in friendship phase, and a commitment phase with three sequential steps each as detailed in said illustrations, and simultaneously comprising a shared story that sustains and engenders faith, belief, trust, respect, and communication in forming a mutual durable romantic relationship comprised of mutual functional lover, friend, and partner status in self for other and other for self;

whereby a mastery of sexual attraction, emotional attraction, intellectual attraction, the personal boundary, emotional energy, intellectual data use and decision-making is illustrated leading to corresponding rewards of lover status, friend status, partner status, durability, happiness, success and freedom, the mastery of the these four character components leading to individual and relationship durable fulfillment, which is the summation of durability, happiness, success and freedom for each individual, and lover, friend, and partner status, termed Mr. Right status and alternately Ms. Right, for individuals in a couple.

The visual method further comprises a step of illustrating observing ego, the observing ego representing a person viewing oneself, the observing ego shown outside the circle and an additional step of illustrating a person's environment, the environment shown outside the circle.

The visual method further comprises a step of illustrating emotional energy as an emotional energy spectrum, the emotional energy spectrum including a negative emotional energy spectrum and a positive emotional energy spectrum, wherein opposite ends of the negative emotional energy spectrum include anxiety at one end, anger at an opposite end and neutrality in a middle as a balance between the two ends, and wherein opposite ends of said positive emotional energy spectrum include confidence at one end, well-being at an opposite end and self-esteem in a middle as a balance between the two ends, self-esteem shown leading to happiness.

The visual method further comprises a step of illustrating intellectual data use as an intellectual data use spectrum, wherein the intellectual data use spectrum having opposite ends with right-brain experience at one end, left-brain education at an opposite end and genius in a middle as a balance between the two ends, striving for genius shown leading to success.

The visual method further comprises the step of illustrating decision-making as a decision-making spectrum, wherein the decision-making spectrum having opposite ends with conscience at one end, intuition at the opposite end and wisdom in a middle as a balance between the two ends, wisdom shown leading to freedom.

It is understood that the preceding description is given merely by way of illustration and not in limitation of the invention and that various modifications may be made thereto without departing from the spirit of the invention as claimed.

What is claimed is:

1. A visual psychoanalysis system called the dating operating system, used to help a user in forming, developing, and securing a relationship with another person and in solving problems involving human interaction, the system comprising:
a series of visual illustrations used to teach, coach and deliver therapy for personal growth, character growth, relationship analysis and corrective advice related to a relationship with another person including a male and a female, and in human groups and their behaviors, the series of visual illustrations comprising;
a series of relationship phase illustrations for the sequence and timing of three phases of a relationship, the series of relationship phase illustrations comprising:
a first attraction phase of a relationship illustration associated with a brainstem as a reptilian portion of a brain, the first attraction phase of a relationship illustration comprising three attraction steps including display of beauty, demonstration of ability to assist another person, and de facto production of status in the male of Alpha-male status;
a second bonding in friendship phase of a relationship illustration associated with a midbrain as a mammalian brain, the bonding in friendship phase of a relationship illustration comprising three bonding steps including a demonstration of mature use of anger via assertiveness to produce the positive emotion and self esteem termed well-being, a demonstration of mature use of anxiety via courage to produce the positive emotion and self esteem termed confidence, and a demonstration of matching of temperament and personality analyzed by and evidenced in productive joint teamwork on a project of mutual benefit to self and another; and
a third commitment phase illustration associated with a cerebral cortex representing a higher brain, the commitment phase illustration comprising three commitment steps: a demonstration of mature personal boundary use, a mature intellectual function use toward joint life's goals between self and an other, and a constructive and mature decision making ability in self and other resulting in a decision to commit to one another;
the brain stem, midbrain, an cerebral cortex together comprising the three brains of Mr. Right and alternately the three brains of Ms. Right, an ideal mate for a user of the system; and
at least one visual illustration of recommended remedies for faults inherent in relationships.

2. The system of claim 1 wherein the first attraction phase comprises at least one de facto production of status taken from the list of de facto producers of status including elevated rank societally in a hierarchy, elevated rank socially in a hierarchy, acquisition of physical territory, acquisition of social territory, acquisition of psychological territory, introduction of a contest of a person among others for attention of a user, introduction of a challenge of a person among others for attention of a user, and introduction of competition of the person among others for attention of a user.

3. The system of claim 1 wherein the bonding in friendship illustration for demonstration of matching of temperament and personality evidenced in productive joint teamwork on a project of mutual benefit to self and an other comprises a four quadrant diagrammed illustration with a horizontal cognitive spectrum axis and an intersecting vertical emotional energy spectrum dividing a circle into four quadrants representing King, Warrior, Magician, and Lover (KWML) as a diagrammed illustration used as a tool of a subject mind operating system including an illustration of an observing ego outside of the circle looking into the circle.

4. The system of claim 3 further comprising a diagrammatic illustration of the horizontal cognitive spectrum axis and the intersecting vertical emotional energy spectrum dividing a circle into four quadrants representing King, Warrior, Magician, and Lover as a diagrammed illustration defining all human behavior and further comprising a detail of the combined balance of the three internal psychological resources and their spectra in a way leading to psychological integration, the most efficient operation of the psyche or self, and the psychological state most likely and efficient at solving personal problems, producing durable fulfillment.

5. The system of claim 3 wherein the subject mind operating system further comprises an illustration of four psychological and individual character building blocks comprising emotional energy leading to happiness; intellect including beliefs, values, and ideas leading to success; decision-making leading to freedom; and personal boundary leading to durability and strength, mastery of the four building blocks combining to produce a desired goal of durable fulfillment.

6. The system of claim 5 further comprising a diagrammatic illustration of the components of the personal boundary showing diversity of function, repair, and contents of the personal boundary in conjunction with the emotional energy, intellectual data use, and decision-making of the subject mind operating system and an associated concept of suffering.

7. The system of claim 5 further comprising a diagrammatic illustration of the components of the subject mind operating system of two individuals engaged in psychological commerce related to relationship forming.

8. The system of claim 5 further comprising a diagrammatic illustration of detailed spectral components of the operation of the intellectual data use resource of the subject mind operating system showing how impairment left-brained education used alone as illustrated by a left brain pilot of a plane leads to obsessiveness and creative failure illustrated by the plane flying into a lightning storm, and how right-brained experience used alone illustrated by a right-brain pilot leads to laziness, confusion, and industrious failure to reach a goal illustrated by flying in a wrong direction.

9. The system of claim 5 further comprising a diagrammatic illustration of detailed spectral components of the operation of the intellectual data use resource of the subject mind operating system showing how simultaneous and balanced use of left-brained education and right-brained experience, illustrated by a combined left-brain and right-brain pilot flying a plane, contributes to the reward of success in reaching a goal illustrated by flying to a desired location, and correcting the failure component of any given individual problem.

10. The system of claim 5 further comprising a diagrammatic illustration of detailed spectral components of a decision-making operation within the decision-making resource of the intellectual data use resource of the subject mind operating system, showing decision making leading to positive momentum with a constructive win/win abundance world view and alternately to negative momentum with a destructive win/lose world view, and alternately regression rather than momentum leading to mental illness and death.

11. The system of claim 1 further comprising an illustration showing the three brains of Mr. Right wherein the brainstem is responsible for instinct and therefore sexual attraction, and the midbrain combined with the cerebral cortex are responsible for the civilizing force of relationships called character to promote bonding in friendship as well as commitment as partners relationally.

12. The system of claim 1 further comprising an illustration showing a user's actions in the attraction, bonding in friendship, and commitment phases in a sequence which takes the form of a story of the user's romantic relationship with a subject person, to produce a resultant relationship status achieved through communication and appeal to the three brains of the person and culminating in the user achieving a committed, emotionally bonded, sexually attracted partnership with a bonded friend and lover in the one personage of the person.

13. The system of claim 1 further comprising a diagrammatic illustration showing the intensity of connection over time of the attraction phase, the bonding phase, and the commitment phase of the relationship leading to a marriage at a culmination of the three phases.

14. The system of claim 1 further comprising a diagrammatic illustration of the subject dating operating system, termed “the Three Brains of Mr. Right,” as a system with a design like a gasoline engine, where the “reptilian brain” causes “ignition” of the energy of the “mammalian brain” as a spark plug ignites gasoline, and the resultant reaction is contained in the bounds of the “higher brain,” where the relationship produces work or a product of joint effort.

15. The system of claim 1 further comprising a diagrammatic illustration of a series of details of the attraction phase wherein sexual attraction occurs to the man's brainstem and showing that attention is simultaneously applied to the other two phases as well.

16. The system of claim 1 further comprising a diagrammatic illustration of the three attraction steps of the attraction phase associated with the brainstem.

17. The system of claim 1 further comprising a diagrammatic illustration of the three bonding steps of the bonding phase associated with the midbrain.

18. The system of claim 1 further comprises a diagrammatic illustration of a relationship between anger and sadness as an emotional extreme with anxiety as an opposite emotional extreme, and as a spectrum with all possible negative emotions contained between as being composed of a geometric portion as anger, and the remaining amount as anxiety, concurrent with the transformation of such negative emotional energy to portions of positive emotional energy called self-esteem, and composed of well-being and confidence respectively, achieved through assertiveness and courage respectively.

19. The system of claim 1 further comprising a diagrammatic illustration of a detail of the anger and well-being end of the spectrum of emotional energy using an anger map, and a diagrammatic illustration of a transformation of the negative emotions of anger or depression into a component of self-esteem called well-being.

20. The system of claim 1 further comprising a diagrammatic illustration of a detail of the anxiety and confidence end of the spectrum of emotional energy using an anxiety map, and a diagrammatic illustration of transforming the negative emotions of anxiety, or avoidance and impulsivity into the component of self-esteem called confidence.

21. The system of claim 1 further comprising a diagrammatic illustration of the three commitment steps of the commitment phase associated with the cerebral cortex.

22. The system of claim 1 further comprising a diagrammatic illustration of the detail of possible dynamics of a relationship between two individuals, in which the relative integration of the parts of the psyche can be beneficial or detrimental to mutual growth, wherein the use of two joined personal boundaries in independence using boundary walls or codependence using boundary holes are considered immature, or destructive-win/lose, and interdependence is the only route to true durable commitment via use of boundary doors, and considered a mature, constructive-win/win relationship.

23. The system of claim 1 further comprising a diagrammatic illustration of a detailed anatomy of a belief, a linking part between the bonding in friendship phase and the commitment phase of the dating operating system associated with intellectual function within the mind operating system, and composed of the central idea within the belief illustrated as a table top, supported by other ideas illustrated as table legs, which are evidence that the idea of the belief is true, and attached to the representation of an individual's mind illustrated as a floor via quanta of emotional energy, wherein potential evidence both supporting and against the central idea of the belief are shown drifting past the top of the table, and wherein a numerous majority of an individual's beliefs are shown composing the summation of beliefs in an individual called an individual's world view, known as a reality or frame.

24. The system of claim 1 wherein the visual illustrations are presented via at least one presentation medium taken from the list of presentation mediums including a book, a booklet, a pamphlet, a loose-leaf binder, a paper based medium, a synthetic sheet based medium, a mailer, a poster, an electronic book, a computer file, a computer software program, a program presented on the world wide web, a web site, a television program, a digital recording medium, a magnetic storage medium, a photographic medium, an electronic mail medium, a projection medium, a slide, a film, a microfilm, an overhead projection medium.

25. A visual psychoanalysis method called the dating operating system, used to help a user in forming, developing, and securing a relationship with another person and in solving problems involving human interaction, the method comprising:
using a series of visual illustrations to teach, coach and deliver therapy for personal growth, character growth, relationship analysis and corrective advice related to a relationship with another person including a male and a female, and in human groups and their behaviors, using the series of visual illustrations comprising;
using a series of relationship phase illustrations for the sequence and timing of three phases of a relationship, using the series of relationship phase illustrations comprising:
using a first attraction phase of a relationship illustration associated with a brainstem as a reptilian portion of a brain, the first attraction phase of a relationship illustration comprising three attraction steps including display of beauty, demonstration of ability to assist a person, and de facto production of status in the male of Alpha-male status;
using a second bonding in friendship phase of a relationship illustration associated with a midbrain as a mammalian brain, the bonding in friendship phase of a relationship illustration comprising three bonding steps including a demonstration of mature use of anger via assertiveness to produce the positive emotion and self esteem termed well-being, a demonstration of mature use of anxiety via courage to produce the positive emotion and self esteem termed confidence, and a demonstration of matching of temperament and personality analyzed by and evidenced in productive joint teamwork on a project of mutual benefit to self and another; and
using a third commitment phase illustration associated with a cerebral cortex representing a higher brain, the commitment phase illustration comprising three commitment steps: a demonstration of mature personal boundary use, a mature intellectual function use toward joint life's goals between self and an other, and a constructive and mature decision making ability in self and other resulting in a decision to commit to one another;
using a combined illustration of the brain stem, midbrain, an cerebral cortex together comprising the three brains of Mr. Right and alternately the three brains of Ms. Right, an ideal mate for a user of the system; and
using at least one visual illustration of recommended remedies for faults inherent in relationships.

26. A method of visual psychoanalysis, the visual method used to help a person view and master four parts of a human psyche, dating, a human mating sequence, and relationship analysis and corrective measure function, the visual method comprising: drawing a circle for illustrating a personal boundary, said personal boundary representing a surrounding of a person's self;
illustrating a person's emotional energy and shown inside the circle;
illustrating a person's intellectual data use and shown inside the circle;
illustrating a person's decision-making and shown inside the circle; and
illustrating three sequential phases of courtship in an attraction phase, a bonding in friendship phase, and a commitment phase with three sequential steps each as detailed in said illustrations, and simultaneously comprising a shared story that sustains and engenders faith, belief, trust, respect, and communication in forming a mutual durable romantic relationship comprised of mutual functional lover, friend, and partner status in self for other and other for self;
whereby a mastery of sexual attraction, emotional attraction, intellectual attraction, the personal boundary, emotional energy, intellectual data use and decision-making is illustrated leading to corresponding rewards of lover status, friend status, partner status, durability, happiness, success and freedom, the mastery of the these four character components leading to individual and relationship durable fulfillment, which is the summation of durability, happiness, success and freedom for each individual, and lover, friend, and partner status, termed Mr. Right status and alternately Ms. Right, for individuals in a couple.

27. The visual method as described in claim 26 further comprising a step of illustrating observing ego, the observing ego representing a person viewing oneself, the observing ego shown outside the circle and an additional step of illustrating a person's environment, the environment shown outside the circle.

28. The visual method as described in claim 26 further comprising a step of illustrating emotional energy as an emotional energy spectrum, the emotional energy spectrum including a negative emotional energy spectrum and a positive emotional energy spectrum, wherein opposite ends of the negative emotional energy spectrum include anxiety at one end, anger at an opposite end and neutrality in a middle as a balance between the two ends, and wherein opposite ends of said positive emotional energy spectrum include confidence at one end, well-being at an opposite end and self-esteem in a middle as a balance between the two ends, self-esteem shown leading to happiness.

29. The visual method as described in claim 26 further comprising a step of illustrating intellectual data use as an intellectual data use spectrum, wherein the intellectual data use spectrum having opposite ends with right-brain experience at one end, left-brain education at an opposite end and genius in a middle as a balance between the two ends, striving for genius shown leading to success.

30. The visual method as described in claim 26 further comprising a step of illustrating decision-making as a decision-making spectrum, wherein the decision-making spectrum having opposite ends with conscience at one end, intuition at an opposite end and wisdom in a middle as a balance between the two ends, wisdom shown leading to freedom.

31. The method of claim 26 comprising presenting the visual illustrations via at least one presentation medium taken from the list of presentation mediums including a book, a booklet, a pamphlet, a loose-leaf binder, a paper based medium, a synthetic sheet based medium, a mailer, a poster, an electronic book, a computer file, a computer software program, a program presented on the world wide web, a web site, a television program, a digital recording medium, a magnetic storage medium, a photographic medium, a slide, a film, a microfilm, an overhead projection medium.
